(19) United States
(12) Patent Application Publication
(10) Pub. No.: US 2018/0285463 A1
(43) Pub. Date: Oct. 4, 2018

(54) ELECTRONIC DEVICE AND METHOD FOR GENERATING USER PROFILE

(71) Applicant: Samsung Electronics Co., Ltd., Gyeonggi-do (KR)

(72) Inventors: Wonsuk CHOI, Seoul (KR); Jiyoon PARK, Gyeonggi-do (KR); Cheolho CHEONG, Seoul (KR); Jaewoong CHUN, Gyeonggi-do (KR)

(21) Appl. No.: 15/765,307

(22) PCT Filed: Oct. 14, 2016
(86) PCT No.: PCT/KR2016/011532

§ 371 Date: Apr. 2, 2018

(30) Foreign Application Priority Data
Nov. 2, 2015 (KR) 10-2015-0152933

(51) Int. Cl. G06F 17/30

(52) U.S. Cl. CPC G06F 17/30867; G06Q 30/0269

(57) ABSTRACT

Electronic devices according to various embodiments of the present disclosure comprise: a communication module; and a processor which is functionally connected to the communication module, wherein the processor may be set to detect the occurrence of an event, check whether the event is a designated event, acquire information corresponding to one or more external electronic devices for the electronic device if the event is the designated event, and generate or update a user profile corresponding to a user of the electronic device on the basis of at least the information.

### TECHNICAL FIELD

Various embodiments of the present disclosure relate to an electronic device and method for generating a user profile in order to provide a customized service or content suitable for a user.

### BACKGROUND ART

An electronic device may incorporate a user or circumstances using a profile predefined by a server. Furthermore, the electronic device may provide a customized service (e.g., product advertising information) or content (e.g., multimedia) based on the profile.

### DISCLOSURE OF INVENTION

### Technical Problem

When an electronic device operates based on a profile of a type identified by a server, it may not accurately incorporate various states of an electronic device user. Furthermore, a user or surrounding condition has been incorporated into the profile using internal information (e.g., data stored in the memory of the electronic device used) of the electronic device used. However, a customized service has not been provided by obtaining information from an external electronic device, and there was no method of controlling an external environment through a profile.

Various embodiments of the present disclosure may provide an electronic device and method capable of solving the limits. For example, various embodiments of the present disclosure can dynamically generate the most suitable profile in an environment in which a user is now present by taking into consideration surrounding environment elements, such as an ambient device or other people, when generating the profile of the user. A profile into which the current state of a user can be most incorporated can be created because a profile is dynamically created by taking into consideration even surrounding environment elements. Furthermore, the most optimized service can be provided to the user because a user profile optimized for a surrounding environment can be created.

Furthermore, various embodiments of the present disclosure may provide a seamless user experience by performing the generation of a profile based on a profile in which a setting value previously used by a user or a service previously provided to the user has been suitably modified in accordance with a current surrounding environment.

### Solution to Problem

An electronic device according to various embodiments of the present disclosures includes a communication module and a processor, wherein the processor may be configured to sense the generation of an event; confirm whether the event is a selected event; obtain information corresponding to one or more external electronic devices for the electronic device if the event is the selected event; and perform the creation or update of a user profile corresponding to a user of the electronic device based on at least the information.

A method performed in an electronic device according to various embodiments of the present disclosure may include sensing the generation of an event; confirming whether the event is a selected event; obtaining information corresponding to one or more external electronic devices for the electronic device if the event is the selected event; and performing the creation or update of a user profile corresponding to a user of the electronic device based on at least the information.

### Advantageous Effects of Invention

Various embodiments of the present disclosure can provide a customized service or content suitable for a user by taking into consideration the current state of the user when creating a profile. Furthermore, various embodiments of the present disclosure can provide a customized service or content suitable for a user by taking into consideration the user or the surrounding environment of an electronic device in addition to internal information of the electronic device used.

### BRIEF DESCRIPTION OF DRAWINGS

FIG. 1 is a block diagram showing a network environment according to various embodiments.

FIG. 2 is a block diagram showing a network environment according to various embodiments.

FIG. 3 is a diagram showing the configuration of a profile according to various embodiments of the present disclosure.

FIG. 4 is a diagram for illustrating a method of creating a profile according to various embodiments of the present disclosure.

FIG. 5 is a diagram for illustrating a method of creating a profile using a prior profile according to various embodiments of the present disclosure.

FIG. 6 is a diagram for illustrating a method of creating the profile of a user using another's profile according to various embodiments of the present disclosure.

FIG. 7 is a diagram for illustrating a method of updating the profile of a user created with reference to another's profile according to various embodiments of the present disclosure.

FIG. 8 is a diagram for illustrating a method of updating the profile of a user created with reference to the state of ambient devices according to various embodiments of the present disclosure.

FIG. 9 is a diagram for illustrating a method of creating a profile based on preference according to various embodiments of the present disclosure.

FIG. 10 is a diagram for illustrating a method of creating a profile in response to the generation of an event related to a profile according to various embodiments of the present disclosure.

FIG. 11 is a diagram for illustrating an operating method of an electronic device using the profile of a user according to various embodiments of the present disclosure.

FIG. 12 is a diagram for illustrating an operation method of an electronic device using a profile according to various embodiments of the present disclosure.

FIG. 13 is a diagram for illustrating an operation method of an electronic device using a sleep profile according to various embodiments of the present disclosure.

FIG. 14 is a diagram for illustrating an operation method of an electronic device using a sleep profile according to various embodiments of the present disclosure.

FIG. 15 is a diagram for illustrating an operation method of an electronic device using a nutrition profile according to various embodiments of the present disclosure.

FIG. 16 is a diagram for illustrating an operation method of an electronic device using a medical profile according to various embodiments of the present disclosure.

FIG. 17 is a block diagram showing an electronic device according to various embodiments.

FIG. 18 is a block diagram showing a program module according to various embodiments.

### MODE FOR THE INVENTION

Hereinafter, various embodiments of this document are described with reference to the accompanying drawings. However, the technology described in this document are not intended to be limited to a specific embodiment, but should be construed as including various modifications, equivalents and/or alternatives of embodiments of this document. Regarding the drawings, similar reference numerals may be used in similar elements.

In this document, an expression, such as “have,” “may have,” “include,” or “may include”, indicates the presence of a corresponding characteristic (e.g., a numerical value, function, operation or an element, such as a part), and does not exclude the presence of an additional characteristic.

In this document, an expression, such as “A or B,” “at least one of A or/and B,” or “one or more of A or/and B”, may include all of possible combinations of listed items together. For example, “A or B,” “at least one of A and B,” or “at least one of A and B” may denote all of cases, (1) including at least one A, (2) including at least one B and (3) including both at least one A and at least one B.

Expressions, such as “the first,” “the second,” “first,” and “second” used in this document, may modify various elements regardless of the sequence and/or importance and are used to only distinguish one element from the other element and do not limit corresponding elements. For example, a first electronic device and a second electronic device may indicate different electronic devices regardless of the sequence or importance. For example, a first element may be named a second element without departing from the scope of right described in this document. Likewise, a second element may be interchangeably named a first element.

When it is described that one element (e.g., a first element) is “operatively or communicatively coupled with/to” or “connected to” the other element (e.g., a second element), it should be understood that one element is directly connected to the other element or may be connected to the other element through another element (e.g., a third element). In contrast, when it is described that one element (e.g., a first element) is “directly connected to” or “directly coupled with” the other element (e.g., a second element), it may be understood that another element (e.g., a third element) is not present between one element and the other element.

An expression used in this document, such as “configured (or set) to ˜”, may be interchangeably used with an expression, for example, “suitable for ˜”, “having the capacity to ˜”, “designed to ˜”, “adapted to ˜”, “made to ˜” or “capable of ˜”, according to circumstances. The expression “configured (or set) to ˜” may not essentially mean only an expression “specifically designed to” in terms of hardware. Instead, in some circumstances, an expression “device configured to ˜” may mean that the device “may perform ˜” along with other devices or parts. For example, a phrase “processor configured (or set) to perform A, B and C” may mean a dedicated processor (e.g., an embedded processor) for performing a corresponding operation or a generic-purpose processor (e.g., a CPU or an application processor) capable of performing corresponding operations by executing one or more software programs stored in a memory device.

Terms used in this document are used to only describe specific embodiments and may not be intended to restrict the scope of other embodiments. An expression of the singular number may include an expression of the plural number unless clearly defined otherwise in the context. Terms used herein, including technical or scientific terms, have the same meanings as those generally understood by a person having ordinary skill in the art described in this document. Terms that belong to terms used in this document and that are defined in common dictionaries may be construed as having meanings identical with or similar to those used in the context of a related technology, and are not construed as having ideal or excessively formal meanings unless explicitly defined otherwise in this document. Terms defined in this document cannot be construed as excluding the embodiments of this document although they are defined in this document according to circumstances.

An electronic device according to various embodiments of this document may include at least one of a smartphone, a tablet personal computer (PC), a mobile phone, a video telephone, an e-book reader, a desktop personal computer (PC), a laptop personal computer (PC), a netbook computer, a workstation, a server, a personal digital assistant (PDA), a portable multimedia player (PMP), an MP3 player, a mobile medical device, a camera and a wearable device, for example. In accordance with various embodiments, the wearable device may include at least one of an accessory type (e.g., a watch, a ring, a bracelet, an ankle bracelet, a necklace, glasses, a contact lens or a head-mounted-device (HMD)), a fabric or clothing-integrated type (e.g., an electronic clothing), a body-attached type (e.g., a skin pad or tattoo) and a bio-transplant type (e.g., an implantable circuit).

In some embodiments, the electronic device may be a home appliance. The home appliance may include at least one of television, a digital video disk (DVD) player, an audio, a refrigerator, an air-conditioner, a cleaner, an oven, a micro oven, a washing machine, an air cleaner, a set-top box, a home automation control panel, a security control panel, a TV box (e.g., Samsung HomeSync™, Apple TV™ or Google TV™), a game console (e.g., Xbox™, PlayStation™), an electronic dictionary, an electronic key, a camcorder and an electronic picture frame, for example.

In other embodiments, the electronic device may include at least one of various medical devices (e.g., various portable medical measurement devices (a blood glucose monitoring device, a heart rate monitor, a blood pressure measuring device and a body temperature measuring instrument), magnetic resonance angiography (MRA), magnetic resonance imaging (MRI), computed tomography (CT), a tomography and an ultrasonic machine), a navigator, a global navigation satellite system (GNSS), an event data recorder (EDR), a flight data recorder (FDR), a vehicle infotainment device, electronic equipment for ship (e.g., a navigator for ship and a gyro compass), avionics, security devices, a head unit for vehicle, industry or home robots, an automatic teller's machine (ATM) in financial institutions, point of sales (POS) at shops and Internet of things (IoT) (e.g., bulbs, various sensors, an electric or gas meter, a sprinkler device, a fire alarm, a thermostat, a streetlamp, a toaster, a health machine, a hot water tank, a heater, and a boiler).

In some embodiments, the electronic device may include at least one of part of furniture or a building/structure, an electronic board, an electronic signature receiving device, a projector, and various measuring devices (e.g., water supply, electricity, gas and wave metering devices). In various embodiments, the electronic device may be a combination of one or more of the aforementioned various devices. The electronic device according to a specific embodiment may be a flexible electronic device. Furthermore, the electronic device according to an embodiment of this document is not limited to the above-described devices and may include new electronic devices in accordance with the development of the technology.

Hereinafter, an electronic device according to various embodiments is described with reference to the accompanying drawings. In this document, the term “user” may denote a person who uses the electronic device or a device (e.g., artificial intelligence electronic device) using the electronic device.

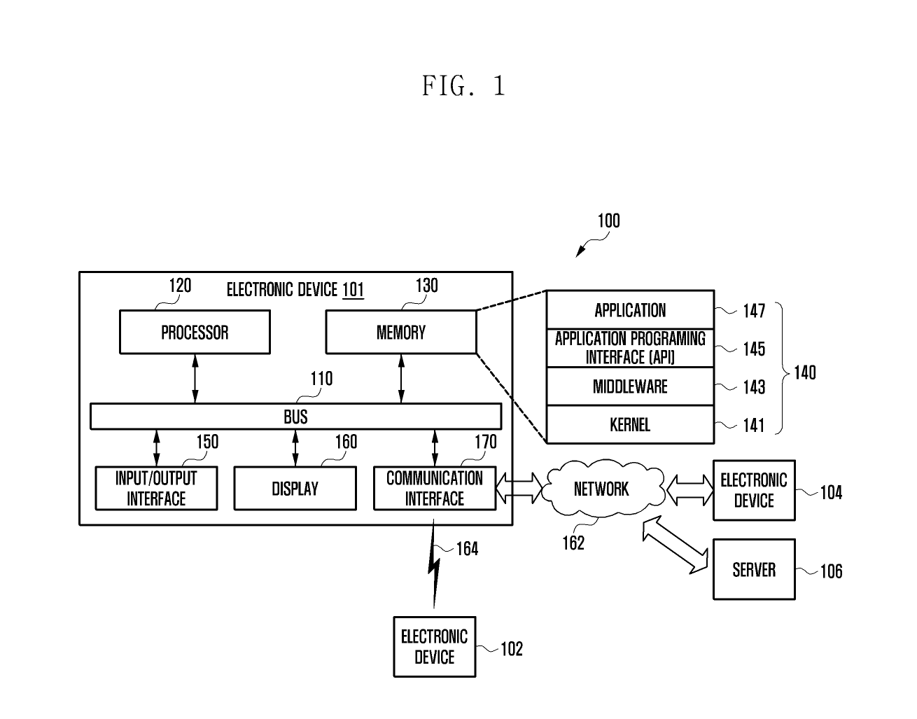

FIG. 1 is a block diagram 100 showing a network environment according to various embodiments. Referring to FIG. 1, an electronic device 101, 102 or 104 and a server 106 may be interconnected over a network 162 or through short-distance communication 164. The electronic device 101 may include a bus 110, a processor 120, memory 130, an input/output interface 150, a display 160 and a communication interface 170. In some embodiments, the electronic device 101 may omit at least one of the elements or may additionally include other elements.

The bus 110 may include, for example, a circuit that connects the elements 110-170 and that transfers communication (e.g., a control message and/or data) between the elements.

The processor 120 may include one or more of a central processing unit (CPU), an application processor (AP) and a communication processor (CP). The processor 120 may execute an operation or data processing regarding control and/or communication of at least one element of the electronic device 101, for example.

The memory 130 may include volatile and/or nonvolatile memory. The memory 130 may store instructions or data related to at least one element of the electronic device 101, for example. In accordance with one embodiment, the memory 130 may store software and/or a program 140. The program 140 may include, for example, a kernel 141, middleware 143, an application programming interface (API) 145 and/or an application program (or “application”) 147. At least some of the kernel 141, the middleware 143 or the API 145 may be called an operating system (OS).

The kernel 141 may control or manage system resources (e.g., the bus 110, the processor 120 and the memory 130) used to execute operations or functions implemented in other programs (e.g., the middleware 143, the API 145 or the application program 147), for example. Furthermore, the kernel 141 may provide an interface capable of controlling or managing system resources by accessing individual elements of the electronic device 101 in the middleware 143, the API 145 or the application program 147.

The middleware 143 may perform a mediation role so that the API 145 or the application program 147, for example, can exchange data through communication with the kernel 141.

Furthermore, the middleware 143 may process one or more task requests received from the application program 147 based on priority. For example, the middleware 143 may assign priority on which the system resources (e.g., the bus 110, the processor 120 and the memory 130) of the electronic device 101 can be used to at least one of the application programs 147. For example, the middleware 143 may perform the scheduling or load balancing of the one or more task requests by processing the one or more task requests based on the priority assigned to the at least one program.

The API 145 is an interface through which for example, the application 147 controls a function provided by the kernel 141 or the middleware 143, and may include at least one interface or function (e.g., an instruction) for file control, window control, image processing or text control, for example.

The input/output interface 150 may play the role of an interface through which an instruction or data received from a user or another external device, for example, may be delivered to other element(s) of the electronic device 101. Furthermore, the input/output interface 150 may output instructions or data, received from other element(s) of the electronic device 101 to a user or another external device.

The display 160 may include, for example, a liquid crystal display (LCD), a light-emitting diode (LED) display, an organic light-emitting diode (OLED) display, a microelectromechanical systems (MEMS) display or an electronic paper display. The display 160 may display, for example, various types of content (e.g., text, images, video, icons and symbols) to a user. The display 160 may include a touch screen, and may receive, for example, a touch, a gesture, proximity or hovering input using an electronic pen or part of the body of a user.

The communication interface 170 may establish communication between the electronic device 101 and an external device (e.g., a first external electronic device 102, a second external electronic device 104 or the server 106), for example. For example, the communication interface 170 may be connected to the network 162 through wireless communication or wired communication, and may communicate with an external device (e.g., the second external electronic device 104 or the server 106).

The wireless communication is a cellular communication protocol, for example, and may use at least one of long-term evolution (LTE), LTE Advance (LTE-A), code division multiple access (CDMA), wideband CDMA (WCDMA), an universal mobile telecommunications system (UMTS), a wireless broadband (WiBro) and a global system for mobile communications (GSM), for example. Furthermore, the wireless communication may include the short-distance communication 164, for example. The short-distance communication 164 may include at least one of wireless fidelity (WiFi), Bluetooth, near field communication (NFC), magnetic stripe transmission (MST) and global navigation satellite system (GNSS), for example.

The MST may generate a pulse based on transmission data using an electromagnetic signal, and the pulse may generate a magnetic signal. The electronic device 101 may transmit the magnetic signal to a point of sales (POS). The POS may detect the magnetic signal using an MST reader and restore the data by converting the detected magnetic signal into an electric signal.

The GNSS may include at least one of a global positioning system (GPS), a global navigation satellite system (Glonass), a Beidou Navigation Satellite System (hereinafter “Beidou”), Galileo and the European global satellite-based navigation system, for example, based on a use area or bandwidth. Hereinafter, in this document, the “GPS” may be interchangeably used with the “GNSS.” The wired communication may include at least one of an universal serial bus (USB), a high definition multimedia interface (HDMI), recommended standard232 (RS-232) and plain old telephone service (POTS), for example. The network 162 may include at least one of telecommunications networks, for example, a computer network (e.g., LAN or WAN), Internet and a telephone network.

Each of the first and second external electronic devices 102 and 104 may be a device having the same type as the electronic device 101 or having a type different from the type of the electronic device 101. In accordance with one embodiment, the server 106 may include a group of one or more servers. In accordance with various embodiments, some or all of operations executed in the electronic device 101 may be executed in another one or a plurality of electronic devices (e.g., the electronic devices 102 and 104 and the server 106). In accordance with one embodiment, if the electronic device 101 has to perform a function or service automatically or in response to a request, the electronic device 101 may execute the function or service or may additionally request at least some associated functions from another device (e.g., the electronic device 102, 104 or the server 106). Another electronic device (e.g., the electronic device 102, 104 or the server 106) may execute a requested function or additional function and transfer the results thereof to the electronic device 101. The electronic device 101 may provide the received results as a requested function or service without any change or may provide the requested function or service by additionally processing the received results. To this end, for example, clouding computing, distributed computing or client-server computing technology may be used.

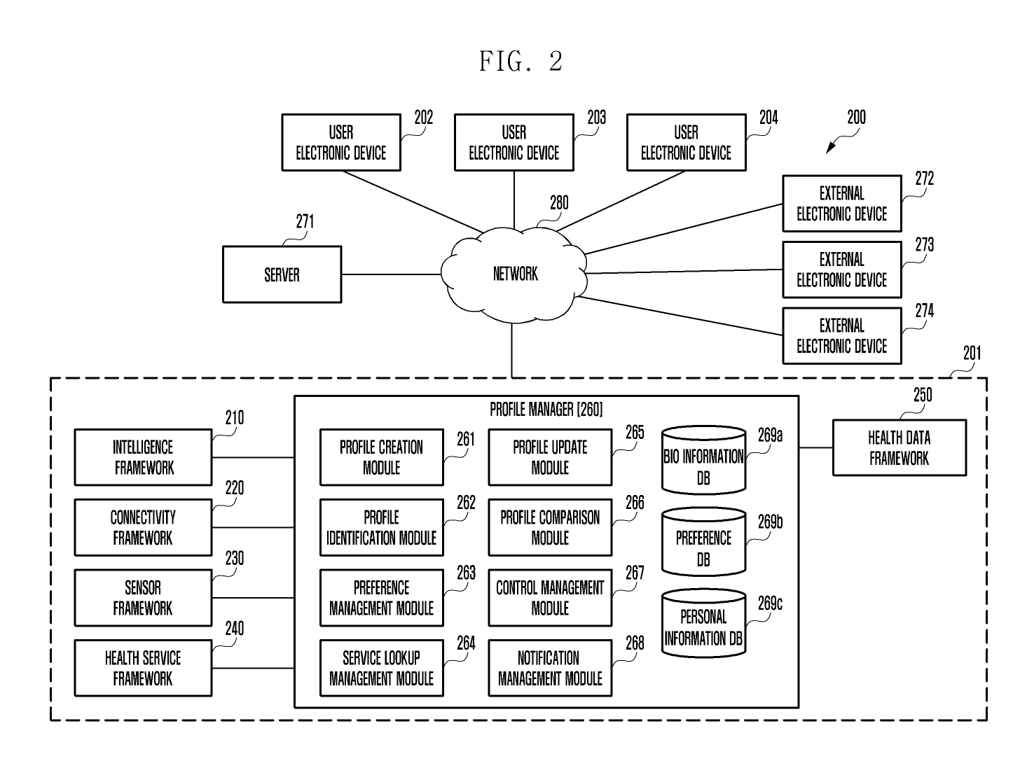

FIG. 2 is a block diagram 200 showing a network environment according to various embodiments.

Referring to FIG. 2, a user electronic device 201, 202, 203 or 204 may be connected to an external electronic device 272, 273 or 274 or a server 271 over a network 280 (e.g., the network 162 or the short-distance communication 164). In this case, the user electronic device 201 may be connected to another user electronic device 202, 203 or 204 over the network 280, and may include some or all of the elements of the electronic device 101 of FIG. 1. The user electronic device 201 may include an intelligence framework 210, a connectivity framework 220, a sensor framework 230, a health service framework 240, a health data framework 250 and a profile manager 260. In this case, the frameworks 210-250 may be supported in the structure of an operating system and may mean a collection of classes or libraries which may be used in an application. Each of the frameworks 210-250 and the profile manager 260 may include software, firmware, hardware or a combination of at least two of them.

The intelligent framework 210 may manage (e.g., collect or update) context information of the user electronic device 201. For example, the intelligent framework 210 may collect information from a profile-related application, may collect information from a module other than the profile-related application, and may generate (or update) context information using the collected information. In other words, the context information may include information (first information) collected from the profile-related application or information (second information) collected other than the profile-related application. In this case, the first information may be information collected from an application related to exercise if the profile is related to the exercise, for example. The information collected from the application related to exercise may be information related to the target of exercise, schedule or exercise history of a user, for example. The second information may be information collected from another application (e.g., an instant messenger, a social network service (SNS) application, a calendar application or a contact address application) not related to the attributes (e.g., exercise) of the profile. Context information managed by the intelligent framework 210 may be used to generate a profile.

The connectivity framework 220 may communicate with the external device (e.g., 202, 203, 204, 271, 272, 273 or 274) over the network 280. For example, the connectivity framework 220 may have the same or similar construction as the communication interface 170 of FIG. 1.

The sensor framework 230 may measure a physical quantity, for example, or may sense the operating state of the electronic device 201.

The health service framework 240 may drive a health-related application. Furthermore, the health service framework 240 may drive the sensor framework 230 and/or the health data framework 250 while operating in conjunction with a health-related application in a platform (e.g., Android, iOS or Tizen).

The health data framework 250 may store and manage data related to health. In this case, the health-related data may include bio information measured and generated by the sensor framework 230 and data (e.g., an exercise record or a medical record) managed by a health-related application.

The profile manager 260 manages a user profile, and may include, for example, a profile creation module 261, a profile identification module 262, a preference management module 263, a service lookup management module 264, a profile update module 265, a profile comparison module 266, a control management module 267, a notification management module 268, a bio information database (DB) 269a, a preference database (DB) 269b and a personal information (DB) 269c.

The profile creation module 261 may recognize the activity of a user while operating in conjunction with the sensor framework 230. For example, the profile creation module 261 may recognize the activity of a user by processing data indicating a physical quantity received from the sensor framework 230. In accordance with various embodiments, the profile creation module 261 may determine whether to generate a profile based on the recognized activity. If the profile is determined to be created, the profile creation module 261 may create the profile related to the recognized activity. For example, if the recognized activity is running, a profile related to running may be created.

The profile creation module 261 may recognize an ambient device while operating in conjunction with the connectivity framework 220. In accordance with various embodiments, the profile creation module 261 may create a profile based on information of a recognized ambient device. For example, the external electronic devices 272˜274 mounted on a running treadmill may communicate with the user electronic device 201 over the network 280 (e.g., near field communication (NFC)). When a user brings the electronic device 201 close to the running treadmill, the user electronic device 201 may recognize that an ambient device is the running treadmill by communicating with the external electronic devices 272˜274 over the network 280. The profile creation module 261 may create a profile (e.g., running profile) associated with the running treadmill.

The profile identification module 262 may recognize the user of a corresponding profile by analyzing the profile and check contents related to the profile. The profile may have been received from another's electronic device through the connectivity framework 220. Depending on the relationship between the user of the user electronic device 201 and other person, contents that may be checked in a received another's profile may be different. If the other person is the user's family, the profile identification module 262 may check all of the contents of the received profile. If the other person is not the user's family, the profile identification module 262 may check some of the received profile.

The preference management module 263 may manage a user's preference for each profile.

The service lookup management module 264 may manage a service lookup table.

The profile update module 265 may manage the update of a profile. The update cycles of profiles may be differently set. For example, the update cycle may be set in a short term or a long term for each profile. That is, the update of a short-term profile may be performed more frequently than that of a long-term profile. If some of the contents of a profile is updated, the profile update module 265 may perform the update of the corresponding profile. For example, if an exercise profile is activated by executing an exercise application, the profile manager 260 may change some of the contents of the exercise profile. In this case, the update may be construed as a term including the concept of generation. That is, in the profile of various embodiments of the present disclosure, generation may mean generating a new profile or updating at least some contents of an existing profile. In this case, the profile creation module 261 and the profile update module 265 do not need to be distinguished, and one module may perform the creation or update of a profile.

The profile comparison module 266 may perform a task of comparing profiles and changing at least some of at least one profile of comparison targets based on the results of the comparison. For example, the profile comparison module 266 may check a target (e.g., may be information related to the strengthening of muscle or may be some items of the contents of a corresponding profile) related to the profile of a user, may selectively obtain some (e.g., the daily quantity of motion related to the strengthening of muscle) of the contents of another's profile based on the checked target, and may change some of the contents of the profile of the user (e.g., change the daily quantity of motion related to the strengthening of muscle) based on the obtained information. In this case, the change may be construed as a term including the concept of generation. That is, in the profile of various embodiments of the present disclosure, generation may mean generating a new profile, updating at least some contents of an existing profile or changing at least some contents of an existing profile into other contents. In this case, the modules 261, 265 and 266 do not need to be distinguished, and one module may perform the creation or update of a profile.

The control management module 267 may manage a parameter for controlling an external device. The control management module 267 may identify a plurality of external devices and may have parameters respectively corresponding to the identified devices. The control management module 267 may remotely control a device by transmitting a control parameter to the corresponding device. If a parameter (e.g., information indicative of the capability of a corresponding device) corresponding to an identified device is not identified by the control management module 267 (e.g., if there is no corresponding parameter in the user electronic device 201), the control management module 267 may transmit a parameter for requesting any information (e.g., exercise contents, such as an exercise time and target calories consumed) to the corresponding device instead of a control parameter. A parameter to be transmitted to the device may be different based on a user's preference or another's profile.

The notification management module 268 may manage notification related to a profile. For example, when any event (e.g., update) related to a profile is generated, the notification management module 268 may guide such a fact (e.g., display a message) to a user. If at least some contents of another's profile related to the profile of a user are updated, the notification management module 268 may receive the notification of the update from another's electronic device through the connectivity framework 220 and may provide the update to a user.

The bio information DB 269a may store a user's bio information. The bio information DB 269a may store data that is stored in the health data framework 250 and that is associated with a profile. Information stored in the bio information DB 269a may be included in the profile of a user and transmitted to an external device or other people. For example, user heart rate information may be included in a running profile and transmitted to an electronic device mounted on a running treadmill.

The preference DB 269b may store preference information of a user received from the user through an input device. The life pattern of a user may be monitored by the sensor framework 230 in real time. Preference information may be updated based on the monitoring information. The preference information may include priority information.

The personal information DB 269c may store a user's personal information (e.g., a name, an ID, height, weight, a nickname, sex, a preference language and a job).

The type of profile according to various embodiments of the present disclosure is described below.

An exercise profile is a profile related to user exercise and may define a user's target of exercise. The user electronic device 201 (e.g., the profile manager 260) may control ambient exercise machinery based on the exercise profile. The exercise profile may be recommended to a suitable person. Furthermore, the exercise profile may be used to recommend a suitable personalized exercise program.

A nutrition profile may include information indicative of a user's nutrition state and information indicative of a user's preference to food. The nutrition profile may be used to recommend food or a restaurant to a user. In order to recommend food or a restaurant, reference may be made to another's profile.

A medical profile is related to a users health state and may include a medical record. The medical profile may be transmitted from the user electronic device 201 to a hospital or doctors electronic device. Accordingly, a patient management service may be provided to a user.

An emotion profile includes information related to a users emotion state. A users emotion and/or other people's emotion may be taken into consideration in device control. The emotion profile may be taken into consideration in the recommendation of content.

A sleep profile may include information related to a users sleep state. The user electronic device 201 (e.g., the profile manager 260) may control ambient home appliances based on the sleep profile. In accordance with one embodiment, the electronic device 201 (e.g., the profile manager 260) may adjust the temperature of an external electronic device (e.g., an air-conditioner) that belongs to the external electronic devices 272˜274 and that is suitable for a users sleep state based on the sleep profile, and may adjust the intensity of light of a lamp.

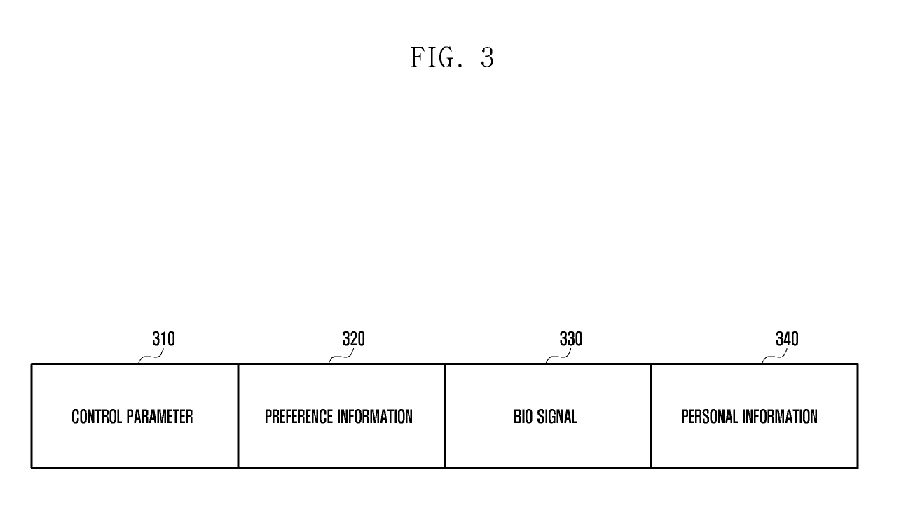

FIG. 3 is a diagram showing the configuration of a profile according to various embodiments of the present disclosure.

The profile may be created to control a device existing in a user's surrounding environment or to receive content suitable for the surrounding environment. The created profile may be transmitted to a device existing in the surrounding environment. The profile may be transmitted based on a standard defined in an Internet of things (IoT) platform, such as open interconnect consortium (OIC) or AllSeen. The profile may be transmitted based on a short-distance wireless transmission standard, such as WiFi, Bluetooth, ANT+ or ZigBee. The profile may be transmitted in the form of XML.

Referring to FIG. 3, the profile according to various embodiments of the present disclosure may include a control parameter 310, preference information 320, a bio signal 330 and personal information 340.

In accordance with various embodiments, the control parameter 310 may include an exercise machinery control parameter, a home appliance control parameter and a medical device control parameter.

The exercise machinery control parameter may include information associated with at least one of speed, a gradient, a difficulty, an exercise time, target calories consumed and weight, for example. The exercise machinery control parameter may be provided for each type of exercise machinery. For example, the parameter may include a parameter for control of the running machines 272˜274 and a parameter for control of the cycle machines 272˜274.

The home appliance control parameter may be prepared for each type of the home appliances 272˜274. For example, the parameter may include a parameter for controlling the power, channel or volume of TV, a parameter for controlling the intensity of air volume of an air-conditioner, a parameter for controlling the power, channel or volume of an audio, a parameter for controlling the power or intensity of illumination of a light, and a parameter for controlling the power or temperature of a heating device.

The medical device control parameter may include a parameter for controlling the functions (e.g., blood pressure measurement and blood sugar measurement) of medical devices. The medical device control parameter may be prepared for each type of the medical devices 272˜274.

The preference information 320 may include, for example, a preference TV channel, the type of preference exercise, the sequence of exercise (e.g., anaerobic exercise after aerobic exercise) and the type of preference food. The exercise preference may include, for example, a preference exercise path, exercise sequence or exercise posture. The nutrition preference may include a preference food type, a preference restaurant or a preference meal time.

The preference may be indicated in a numerical value. For example, if a numerical value assigned to a running profile is higher than a numerical value assigned to an anaerobic exercise profile, this may mean that a user prefer running over anaerobic exercise.

In preference, when the profiles of users collide against each other (e.g., if a numerical value assigned to a running profile and a numerical value assigned to an anaerobic exercise profile are the same), the electronic device 201 (e.g., the profile manager 260) may assign priority to preferences. For example, if the running profile has now been activated and the anaerobic exercise profile has been deactivated, priority may be given to running.

In preference, when the profile of a user collides against another's profile, the electronic device 201 (e.g., the profile manager 260) may give priority to the profile of a selected person (e.g., a child of the child and a mother). In order to determine priority, negotiation is possible between the user electronic devices 201˜204.

Priority may be changed based on a user's life pattern. For example, a profile that is recently used frequently may have higher priority. Preference may be machine-learnt based on a life pattern. For example, if a user has a style of first performing aerobic exercise and then performing anaerobic exercise, priority of an exercise profile may be set to first activate an aerobic exercise profile and to then activate an anaerobic exercise profile.

Preference may be set in a profile based on the bio signal 330. For example, preference for food may be set based on a user's nutrition state that is now measured. For example, as a result of the measurement of the nutrition state, if it is determined that the user has high obesity or cholesterol, priority of vegetarian diet in the nutrition profile may be increased.

The type of preference set in any profile may have an effect on another profile. For example, if a user's preference is meat in a nutrition profile, the setting value of quantity of motion of an exercise profile may increase. A GUI configuration preferred by a user may also be included in preference. A necessary portion of a frequently used GUI or a specific exercise may also be included in the GUI configuration. For example, during running on a running training apparatus, heart rate information and body heat information may be displayed in a GUI.

The bio signal 330 may include, for example, a heart rate, blood pressure, blood sugar, body heat, a skin moisture ratio, oxygen saturation, electrocardiogram, electroencephalogram, electromyogram, the current number of steps, current calories consumed, an emotion state (pleasure, gloom, sorrow, surprisal or irritancy), and the degree of stress.

The personal information 340 may include, for example, height, weight, a nickname, an ID, information of a subscribed insurance company, information of a medical hospital, a medical history, and a privacy level.

In accordance with various embodiments of the present disclosure, the electronic device 201 (e.g., the profile manager 260) may dynamically change a profile based on a privacy level. For example, the privacy level may be set depending on whether a user has been authenticated. The electronic device 201 (e.g., the profile manager 260) may set the privacy level of a user who has been authenticated as the owner of a corresponding device to be higher than the privacy level of a counterpart that has not been authenticated. Furthermore, the privacy level may be set depending on whether a device has been authenticated. An authenticated device may be set to be a higher level than an unauthenticated device. Such a privacy level may be taken into consideration in creating a profile. For example, if a user or device has a low privacy level because it has not been authenticated, bio information may be excluded from the configuration of a profile. If a device or user has a higher privacy level because it has been authenticated or if the privacy level of a device (e.g., running training apparatus) increases because the number of times that the device has been used is increased, the configuration of a profile may become more diverse and may become more personalized. For example, the electronic device 201 (e.g., the profile manager 260) may add bio information to the configuration of a profile.

In accordance with various embodiments of the present disclosure, the electronic device 201 (e.g., the profile manager 260) may dynamically change a profile based on an ambient environment of a device. For example, the configuration of a profile may be different depending on whether a user takes exercise indoors or outdoors. For example, the profile manager 260 of the user electronic device 201 may recognize that a user is located outside (i.e., the place other than a fitness center equipped with exercise machinery capable of communicating with the user electronic device 201), for example, while operating in conjunction with the connectivity framework 220 and the sensor framework 230, and may exclude the control parameter 310 from the configuration of a profile if it recognizes that the user takes exercise outside. That is, if the user takes exercise outside, the electronic device 201 (e.g., the profile manager 260) may create a profile without a parameter for control of exercise machinery. Furthermore, if exercise machinery is not recognized or if the capability of exercise machinery is not obtained, the control parameter 310 may be excluded in creating a profile.

In accordance with various embodiments of the present disclosure, a profile may include a long-term profile and a short-term profile. The long-term profile may be a user's basic profile, for example, and may be updated when a user's life pattern is trained by machine learning. The short-term profile may be a variation generated from a long-term profile. For example, if a long-term profile is an exercise profile, a short-term profile may be a profile regarding running of exercises. Alternatively, if a long-term profile is a running profile, a short-term profile temporarily associated with running may be created. A short-term profile may be created based on the activity of a user. For example, a short-term running profile suitable for a user's a current activity (e.g., running) may be created. If an ambient environment is recognized to be unsafe, a short-term profile may be created.

In accordance with various embodiments of the present disclosure, the attributes of a profile may be determined to be a short term or a long term based on a validity period. For example, the validity period of a short-term profile may be several minutes to several tens of minutes, and the validity period of a long-term profile may be relatively longer.

In accordance with various embodiments of the present disclosure, the electronic device 201 (e.g., the profile manager 260) may set the validity period of a profile fixedly or variably. A fixed profile may be valid only for a given validity period. The validity period of a variable profile is not fixed, but may vary. For example, when the activity of a user is terminated (e.g., running is terminated), the variable profile may be invalidated. When the activity of the user starts, the variable profile may be valid.

In accordance with various embodiments of the present disclosure, the parameter of a profile may include a static parameter, a semi-dynamic parameter and a dynamic parameter. The static parameter may include a parameter that is rarely changed or very slowly changed, such as height and weight, a parameter that is rarely changed, such as sex, nationality, and a language, and a parameter that is periodically changed or has a slow cycle, such as an age. The semi-dynamic parameter is maintained for a schedule period, and may include, for example, a target, a medical history, a mood and a privacy level. The dynamic parameter is dynamically changed by an external variable or internal variable, and may include, for example, preference, a control parameter, and measured bio information. A variable affecting the dynamic parameter may be external device information, another's profile, another profile (a profile of a different type or a prior profile) and a life pattern.

In accordance with various embodiments of the present disclosure, a profile may include a private profile and a public profile. The private profile may be used (or shared) in a safe environment, an authenticated device or an authenticated counterpart, for example, and may include, for example, bio information or personal information, such as a personal medical record. The public profile may be used (or shared) in an unsafe environment, an unauthenticated device or an unauthenticated counterpart, and may include information that may be made public, such as a key or weight.

In accordance with various embodiments of the present disclosure, the electronic device 201 (e.g., the profile manager 260) may set a relationship between profiles and store information related to the set relationship. Furthermore, the electronic device 201 (e.g., the profile manager 260) may simultaneously activate profiles that are related to each other. In accordance with one embodiment, profiles having the same type may be influenced mutually over time. That is, a profile (prior profile) that has been early created in time may have an effect on a subsequently created profile (posterior profile). For example, in the case of a nutrition profile, food information eaten by a user in the morning and corresponding calorie consumption information may have an effect on a nutrition profile created afternoons. In the case of an exercise profile, exercise contents and calorie consumption information yesterday may have an effect on an exercise profile created today. In accordance with another embodiment, the electronic device 201 (e.g., the profile manager 260) may set a relationship between profiles having different types. For example, a change of a nutrition profile may have an effect on an exercise profile. If information related to get-together is included in schedule information of a nutrition profile, it is expected that a user's amount of meal will increase. Accordingly, an exercise profile may be updated to increase a user's quantity of motion. In accordance with another embodiment, setting information of a sleep profile may be changed based on information (e.g., an increase of a fatigue degree attributable to long-time driving) tracked in a driving profile.

In accordance with various embodiments of the present disclosure, a profile may be stored in various devices. For example, a storage device may include a central server, a local computer, a private server, a personal device and a wearable device. The central server 271 may be accessible by the plurality of user electronic devices 272˜274. If the central server 271 is updated with other people's information, the central server may transmit other people's information to the user electronic device 201. The local computer and the private server may be accessible by an authenticated user. Sensitive personal information may be stored in the local computer and the private server. The personal device (e.g., the user electronic device 201) may store sensitive personal information. In the personal device, update may be possible fast and consistently. Furthermore, bio information measured in the personal device in real time may be incorporated into a profile. If the wearable device (e.g., the user electronic device 202) is carried by a user, it may store a profile (secondary profile), that is, a modified form of a profile (primary profile) stored in the personal device (e.g., the user electronic device 201). Furthermore, the wearable device may include a sensor and measure a user's bio information through the sensor.

In accordance with various embodiments of the present disclosure, when profile-specific data is received by the user electronic device 201 or generated by the user electronic device 201, the user electronic device 201 (e.g., the profile manager 260) may create (or update) a profile. When information capable of specifically describing user surroundings or a user's state, such as a user's exercise information, health information, emotion information, sleep information, medical information, user ambient device information, and location information, is identified by the user electronic device 201 (e.g., the profile manager 260), a profile may be created (or updated). Furthermore, when information related to a profile is transmitted from a wearable device, an external device (e.g., a device that may be connected to the user electronic device 201 in the IoT environment) or a server to the user electronic device 201, a profile may be created (or updated). If the existing profile information has information insufficient to incorporate a corresponding environment, elements within the profile may be updated based on information recognized or received by the electronic device.

In accordance with various embodiments of the present disclosure, the electronic device 201 (e.g., the profile manager 260) may create (or update) a profile in real time. For example, when a user's state and ambient information that is monitored and analyzed in real time is changed, a profile is updated in real time, so the profile can be managed most optimally based on the current state of a user.

In accordance with various embodiments of the present disclosure, the electronic device 201 (e.g., the profile manager 260) may set a validity period in a profile. When the validity period expires, the electronic device may create (or update) a profile.

In accordance with various embodiments of the present disclosure, the electronic device 201 (e.g., the profile manager 260) may create (or update) a profile every cycle set by a user or system (e.g., the profile manager 260). The electronic device 201 (e.g., the profile manager 260) may select a profile associated with a user's current ambient condition and user state information and perform update on the selected profile.

In accordance with various embodiments of the present disclosure, the electronic device 201 (e.g., the profile manager 260) may perform the creation (or update) of a profile in response to a direct request from a user. For example, the electronic device 201 (e.g., the profile manager 260) may display a plurality of profiles (e.g., profiles related to exercise, nutrition, medical treatment, emotion and sleep) to a user in a list form, and may perform the creation (or update) of a profiled selected by the user. The profiles may be arranged in the list based on a sequence having high similarity with the activity of the user.

In accordance with various embodiments of the present disclosure, the electronic device 201 (e.g., the profile manager 260) may perform the creation (or update) of a profile in response to a change of a user's bio information and/or emotion information. The profile manager 260 of the user electronic device 201 may recognize a user's emotion information, such as pleasure, sorrow or tension, while operating in conjunction with the sensor framework 230 or may recognize a user's bio information, such as blood pressure, a heart rate or electrocardiogram information, and may create a profile based on the recognized information. In this case, the created profile of the user may be associated with information of an external device or ambient other people around the user electronic device 201.

In accordance with various embodiments of the present disclosure, the electronic device 201 (e.g., the profile manager 260) may perform the creation (or update) of a profile in response to a change of an external environment.

The user electronic device 201 (e.g., the profile manager 260) may recognize the external electronic devices 272˜274 around a user through short-distance wireless communication (e.g., the connectivity framework 220). Alternatively, the user electronic device 201 may recognize the external electronic devices 272˜274 by receiving information of other external electronic devices 272˜274 (e.g., a running machine around a user) from an external electronic device (e.g., the server 271). The user electronic device 201 (e.g., the profile manager 260) may recognize an external environment through communication with an external device. For example, the current location of the user electronic device 201 may be recognized based on information received from the server 271 or recognized ambient devices 272˜274. For another example, the user electronic device 201 (e.g., the profile manager 260) may recognize an external environment by analyzing information received from an external device (e.g., the server 271 or recognized ambient devices 272˜274) and information (e.g., sensing information) generated from the user electronic device 201. For example, the user electronic device 201 may identify the current location of the user (e.g., recognizes whether the current location is a fitness center or restaurant) based on point of interest (POI) information (shop, restaurant) received from the server 271 for a corresponding area and information (e.g., location information or sensing information) obtained from the user electronic device 201.

The user electronic device 201 (e.g., the profile manager 260) may recognize an external environment, may recognize the activity of a user in the recognized external environment, and may create a profile related to the external environment and activity. For example, when food smell is sensed by a gas sensor, the user electronic device 201 may determine that the current location of the user electronic device 201 is a restaurant by confirming location information and POI information. When the current location is determined to be a restaurant, the user electronic device 201 may select a nutrition or medical profile from a plurality of profiles and may create or update information about a preference food within the nutrition profile based on a selected food menu.

In accordance with various embodiments of the present disclosure, the creation (or update) of a profile may be performed as a specific application is executed. For example, when an application for health management is executed, a health profile may be created. Additionally, an external device associated with the health profile may be searched for through the connectivity framework 220, and a profile that may be used when the retrieved external device is controlled may be created.

In accordance with various embodiments of the present disclosure, the creation (or update) of a profile may be performed in response to the activity of a user. For example, when the running of a user is recognized using an acceleration and motion sensor, a running profile may be created.

In accordance with various embodiments of the present disclosure, when the presence of an external device around a user is recognized, the creation (or update) of a profile may be performed. When fitness equipment or a multimedia playback device is searched for, the user electronic device 201 may create an external device-specific profile based on the attributes (or type or capability) of an ambient external device. For example, when a user brings the electronic device close to a running training apparatus, the running training apparatus may be recognized by the user electronic device 201 through short-distance wireless communication (e.g., NFC). Accordingly, an exercise profile may be created.

In accordance with various embodiments of the present disclosure, the creation (or update) of a profile may be performed in response to the generation of a profile-specific event. For example, if a schedule has been set in a calendar and when an event is generated at a corresponding time of the schedule, a schedule-specific profile may be created in response to the generation of the event. For example, if a dinner meal appointment has been included in schedule information and when the corresponding appointment time is reached, a nutrition profile may be created.

In accordance with various embodiments of the present disclosure, when another's profile is recognized, the creation (or update) of a profile may be performed. A profile from the electronic devices 202˜204 of other persons who belong to other persons adjacent to a user and who has device, environment or state information similar to that of the user may be shared by the user electronic device 201. The profile manager 260 of the user electronic device 201 may obtain information associated with a user from the shared information and use the obtained information for the generation and update of a profile of the user. For example, the electronic device 201 (e.g., the profile manager 260) may receive health profiles from the electronic devices 202˜204 of other persons, may select the health profiles of other persons having high association (e.g., medical histories are the same) by comparing the received health profiles with a user's health profile, and may update the user's health profile using the selected health profiles.

In accordance with various embodiments of the present disclosure, when a user is authenticated by an external device, the electronic device 201 (e.g., the profile manager 260) may perform the creation (or update) of a profile. For example, if a function capable of recognizing a user's bio information, such as fingerprint recognition, face recognition, iris recognition or voice recognition, is installed in an external device, the external device may recognize a selected user using the function and create a user profile corresponding to the recognized user. For example, if the external device is one type of exercise machinery, when a specific user is recognized in the exercise machinery, a corresponding user's exercise profile may be created.

In accordance with various embodiments of the present disclosure, when another's profile is updated, the electronic device 201 (e.g., the profile manager 260) may perform the creation (or update) of a profile. When another's profile is updated, another's electronic device may provide update information to the user electronic device 201 that has referred another's profile. The profile manager 260 of the user electronic device 201 may update a corresponding profile (i.e., a profile previously created using another's profile) using received update information. The update may be automatically performed. Alternatively, the profile manager 260 of the user electronic device 201 may query a user whether to update a profile (e.g., displays a query message). When the user accepts the update, the profile manager 260 may perform the update of the profile. Alternatively, the update may be optionally performed. For example, the electronic device 201 (e.g., the profile manager 260) may list update information, for example, may display the list to a user, may receive the selection of at least one of the update items of the list from the user, and may update only the configuration of a profile related to the selected update item.

The electronic device 201 (e.g., the profile manager 260) may receive information related to an update cause from another's electronic device. For example, another's electronic device may search for a new device, and may newly generate a profile into which such a condition has been incorporated or may change some items of an existing profile. Another's electronic device may transmit “device search” to the user electronic device 201 as an update cause.

In accordance with various embodiments of the present disclosure, when a profile is updated, another profile associated with the updated profile may be updated. For example, if an exercise profile has been created by using contents included in a nutrition profile, when information of the nutrition profile is updated, the exercise profile may also be updated. For example, if vitamin A is updated to be insufficient in a user's nutrition profile, food capable of supplementing vitamin A may be updated in the menu of an exercise profile.

In accordance with various embodiments of the present disclosure, when a profile is created (or updated), the electronic device 201 (e.g., the profile manager 260), may perform an associated and subsequent operation. For example, when the creation or update of a profile is generated, the electronic device 201 (e.g., the profile manager 260) may display such a fact to a user through a graphic user interface. The electronic device 201 (e.g., the profile manager 260) may query a user whether the creation or update of the profile will be shared with other persons. If the user permits the sharing, the electronic device 201 may share creation or update information with another's electronic device.

In accordance with various embodiments of the present disclosure, when a profile is created, updated, transmitted or received, the electronic device 201 (e.g., the profile manager 260) may perform a filtering operation for the profile. The electronic device 201 (e.g., the profile manager 260) may receive a profile having the same type as a currently activated profile from the outside. The user electronic device 201 may receive an authenticated another's profile from the outside.

The profile manager 260 may filter an element that belongs to the received elements of a profile and that is necessary for a user. For example, if fitness equipment requires a parameter for control and does not require other contents, the user electronic device 201 may extract an exercise machinery control parameter from a received profile and may create or update a user's exercise profile using the obtained parameter.

The electronic device (e.g., the profile manager 260) may request necessary information from another's electronic device. For example, a field that requests an exercise machinery control parameter may be present in a message for requesting a profile. Accordingly, necessary information may be transmitted from another's electronic device to the user electronic device 201 through such a field.

In accordance with various embodiments of the present disclosure, the electronic device 201 (e.g., the profile manager 260) may update a profile if consistently measured information affects the profile.

In accordance with various embodiments of the present disclosure, the electronic device 201 (e.g., the profile manager 260) may collect the source of a profile from a profile-related application within the user electronic device 201.

In the case of an exercise profile, user input information may include a user's state, target of exercise and exercise schedule. The exercise-related application may provide the user input information to the user electronic device 201, for example, the intelligent framework 210.

Although a user do not directly input information to an exercise-related application, the corresponding application may provide checkable information as the source of a profile to the intelligent framework 210. For example, the exercise-related application may check a user's quantity of motion, calories consumed and a change of weight using the number of times that the user has entered and exited from a fitness center, the number of steps, a running time, speed, the type of anaerobic exercise, an anaerobic exercise time and an anaerobic exercise number, and may provide the checked information to the intelligent framework 210. The intelligent framework 210 may calculate a change of the user's health state based on the checked information. The calculated information may become the source of the creation or update of a profile.

In another embodiment, life-pattern information related to the profile of a user may be stored along with the profile. For example, when a user's abnormal body change is sensed in a current health profile, a previous element that has affected the change of the body may be checked.

In the case of a nutrition profile, user input information may include the type, amount and calories of eaten food. A nutrition-related application may provide the user input information to the user electronic device 201, for example, the intelligent framework 210. The nutrition-related application may check the calories and type of food using a photo of the food and a menu, and may provide the checked information as the source of the nutrition profile to the intelligent framework 210.

In the case of a sleep profile, user input information may include a sleep schedule, a sleep pattern, a sleep-related disease and sleeping hours. The sleep-related application may provide the user input information to the user electronic device 201, for example, the intelligent framework 210. The sleep-related application may monitor a user's motion (e.g., when the user goes to bed, how many times the user tosses and turns, and when the user sleeps a sound sleep) and breathing, and may provide the monitored information as the source of the sleep profile to the intelligent framework 210. A user may provide an alarm to the user electronic device so that the corresponding profile is updated whenever the user lies down on the bed and gets up. The electronic device 201 (e.g., the profile manager 260) may monitor a user's sleeping hours and quality of sleep and update the sleep profile based on the monitored results. The sleep disease of a user may include insomnia, hypnolepsy, a sleep apnea syndrome and somnambulism. Such a sleep disease may be directly input by a user or may be checked in such a manner that the electronic device 201 monitors a user's sleep pattern. The electronic device 201 (e.g., the profile manager 260) may update a user's sleep profile based on the checked sleep pattern data.

In the case of a medical profile and an emotion profile, a related application may provide the intelligent framework 210 with user input information and/or checkable information as the source of a corresponding profile.

In accordance with various embodiments of the present disclosure, a profile-related application within the user electronic device 201 may obtain bio information and provide the obtained bio information as the source of a profile to the intelligent framework 210. For example, the application may recognize a user's bio information and a real-time change through the sensor framework 230 or the external devices 272˜274 (e.g., a wearable device). The checkable bio information may include, for example, a heart rate, a thought wave type, a respiration state, a degree of tension, emotion and a degree of muscle tension.

In accordance with various embodiments of the present disclosure, the source of a profile may be collected from a profile-related application or other modules (e.g., an application, the memory and a sensor) within the user electronic device 201.

A calendar application may provide the intelligent framework 210 with schedule information, for example, a get-together place, a meal appointment, and exercise plan and a travel plan associated with a profile (e.g., an exercise profile or a nutrition profile) as the source of the profile. When a get-together plan is registered with a user's schedule, it is expected that calories are more taken than normal. Accordingly, the electronic device 201 (e.g., the profile manager 260) may modify the exercise profile to suggest a more quantity of motion than normal. When an exercise plan is registered with a user's schedule, it is expected that more exercise is performed than normal. Accordingly, the electronic device 201 (e.g., the profile manager 260) may modify the exercise profile to suggest a smaller quantity of motion than normal. If a travel plan is registered with a user's schedule and a busy schedule is expected in the future, an increase of the quantity of motion may be suggested to a user.

A bio-related application may recognize a change in the bio rhythm of a user (woman) and provide the intelligent framework 210 with such change information as the source of a profile. For example, the electronic device 201 (e.g., the profile manager 260) may modify the exercise profile to suggest an exercise method and the quantity of motion based on a change of the bio rhythm.

A communication-related application (e.g., SNS, IM or e-mail) may provide the intelligent framework 210 with a user's personal details and a contact address made public through conversations or SNS, for example, as the source of a profile. The electronic device 201 (e.g., the profile manager 260) may predict eaten food, calories, etc. by analyzing received information (e.g., conversation). The electronic device 201 (e.g., the profile manager 260) may change the exercise profile based on the predicted data. For example, a short-term exercise profile in which a larger or smaller quantity of motion is suggested than normal may be created. The electronic device (e.g., the profile manager 260) may check a user's current feelings and state through context awareness using SNS or an IM message. A current target of exercise and the type of exercise may be changed based on such data. Such a change may be suggested to the user. If the user accepts the change, an exercise profile into which the change has been incorporated may be created.

In accordance with various embodiments of the present disclosure, the electronic device 201 (e.g., the profile manager 260) may create or update a profile using various convergence methods.

The electronic device 201 (e.g., the profile manager 260) may create or update a profile with reference to information related to an external environment and other people as a source in addition to data obtained by a profile-related application or other module. The created or updated profile is converged with an external environment and another's profile and thus may become a base in obtaining a more useful user profile and suggesting a more useful service and environment.

The electronic device 201 (e.g., the profile manager 260) may create or update an exercise profile with reference to obtained external environment data (e.g., a user's current location and indoor/outdoor elements and weather information) as the source of the exercise profile in addition to a target checked through an exercise-related application.

The profile manager 260 may create or update a sleep profile for providing a better sleep environment with reference to obtained external environment data (e.g., light or noise) as the source of the sleep profile in addition to a user's sleep pattern and sleep disease checked through a sleep-related application.

The electronic device 201 (e.g., the profile manager 260) may refer to a target of exercise and the quantity of motion in the profile of other people or an exercise group to which other people belong or may refer to an expert's suggestion, may modify and suggest the quantity of motion, an exercise method and the menu of edible food based on the results of the reference.

The electronic device 201 (e.g., the profile manager 260) may dynamically check a user's bio information based on the internal data of a profile-related application, may check a user's health and disease information based on the external data of the profile-related application, and may create a health profile suitable for the user. Furthermore, the profile manager 260 may check the menu of the day based on the schedule and carte of the day, and may warm the user against allergy-causing food and danger food by comparing the checked menu with the health profile. Furthermore, the electronic device 201 (e.g., the profile manager 260) may rapidly recognize a danger condition with reference to an ambient group or another's profile and may provide fast feedback when a dangerous condition occurs.

In accordance with various embodiments of the present disclosure, the electronic device 201 (e.g., the profile manager 260) may collect the source of a profile from the external electronic devices 272˜274.

Information indicative of the capability of the external electronic devices 272˜274 may include, for example, a brand name, a model name, a protocol, an ID, a machine type, a control parameter, a mode, operation history-related device information, a current status, an authentication key, location information, an operation time, an IP address and available connectivity information.

The electronic device 201 (e.g., the profile manager 260) may identify what are the profile-specific devices 272˜274 based on information indicative of the capability received through the connectivity framework 220. For example, the identified profile-specific devices 272˜274 may be fitness equipment, a display device, an audio device, home appliances, a medical device or a wearable device. The electronic device 201 (e.g., the profile manager 260) may search the network 280 for the driver or application of the identified device 272˜274, and may install the driver or application in the memory. The electronic device 201 (e.g., the profile manager 260) may identify the type of device by installing the driver or application using a plug-in-plug function and may obtain information related to the device.

The electronic device 201 (e.g., the profile manager 260) may identify a function, service or content that may be provided by the identified device. The type of function that may be provided may be as follows.
specification: resolution, a supported function, an application program interface (API), measurement accuracy, measurement information and operation capability
another's electronic device, other people, the ability of another group to use information and the ability to deliver information
API for control of a device
an API-related parameter (required information)

The function of TV may include, for example, audio output, display and smart hub. The function of a complex gas sensor may include the sensing of CO, CO2 and sulfur dioxide and whether it is available in a corresponding location. The function of a running training apparatus may include a heart rate check, speed, mileage, an information exchange function with a wearable device, and an API.

Capability information of the identified device may be stored in the form of a service lookup table. The service lookup table may include a unique identifier and function of the device. The service lookup table may use a platform, such as web of things (WoT) and open interconnect consortium (OIC).

In accordance with various embodiments of the present disclosure, the electronic device 201 (e.g., the profile manager 260) may recognize an ambient device using various communication methods.

The electronic device 201 (e.g., the profile manager 260) may identify an ambient external device through a wireless short-distance communication network (e.g., the network 280). The short-distance communication method may be, for example, WiFi, Bluetooth, NFC or a beacon. The electronic device 201 (e.g., the profile manager 260) may receive information related to the location of an ambient device from the server through another communication network (e.g., cellular communication).

The electronic device 201 (e.g., the profile manager 260) may collect information related to an electronic device (e.g., another's electronic device, fitness equipment, a display device or an audio device) operatively connected to a corresponding server or a host electronic device by accessing a specific server, a network hub or a host electronic device. Alternatively, the user electronic device 201 may be connected to the external electronic devices 272˜274 through a peer to peer (P2P). For example, when a user enters a fitness center, the user electronic device 201 accesses the fitness center server 271, user information is transferred from the user electronic device 201 to the server, and the user may be recognized by the server. Accordingly, the profile manager 260 of the user electronic device 201 may search the server for information related to the location of the center (based on a cell ID, NFC at an entrance/exit location, Beacon information, AP information or a corresponding institute name). The electronic device 201 (e.g., the profile manager 260) may identify a location identifier (e.g., a physical address, a building name, an office, a branch name or a company name) related to the retrieved location information, and may recognize information related to the location identifier, for example, a list of already registered electronic devices and the capability thereof.

The electronic device 201 (e.g., the profile manager 260) may obtain ambient environment data through an input device (e.g., a camera or a microphone), and may recognize an ambient device by analyzing the environment data. For example, the electronic device 201 (e.g., the profile manager 260) may recognize that exercise machinery is present on the periphery, for example, by voice-recognizing a conversation between a user and other people. The electronic device 201 (e.g., the profile manager 260) may recognize information, such as barcode, QR code or text, by analyzing an image obtained through a camera, and may perform communication for a connection with an ambient device based on the recognized information.

In accordance with various embodiments of the present disclosure, if a plurality of recognized devices is present, the electronic device 201 (e.g., the profile manager 260) may perform communication with a device that belongs to the recognized device and that is associated with a user's current activity. For example, a device (e.g., running treadmill) associated with a running profile may be selected as a communication target (e.g., a target to be controlled by the user electronic device 201). If the recognized devices are not associated with running, in order to replace them, a cycle machine or a step machine capable of aerobic exercise like running may be selected as a control target. If the recognized devices are not associated with running like a device for anaerobic exercise, the corresponding device may not be selected as a communication target. A device seen or indicated by a user or another person through an image may be selected as a control target

When a plurality of devices is recognized, the electronic device 201 (e.g., the profile manager 260) may select a communication target based on use history information. The use history information may include the capability, specification, use number, brand name, manufacturing company name and function-related information of a device. For example, the electronic device 201 (e.g., the profile manager 260) may select a device that belongs to the recognized devices and that has the same brand name as a previously used device as the first priority.

The electronic device 201 (e.g., the profile manager 260) may track the activity of a user using the sensor framework 230 (e.g., an acceleration sensor, a gyro sensor, a pedometer, an altitude sensor or an atmosphere sensor), and may identify the type of activity.

If a recognized device is a device (e.g., an audio device) capable of playing back multimedia content although it has low association with a profile (e.g., an exercise profile), the electronic device 201 (e.g., the profile manager 260) may control the recognized device based on a user's personal information (e.g., preference music). Accordingly, the user may listen to preference music during exercise.

The electronic device 201 (e.g., the profile manager 260) may receive information necessary for a profile-related application from an ambient sensor through the connectivity framework 220. For example, the electronic device 201 (e.g., the profile manager 260) may receive information related to an external environment (e.g., a UV index, environment gas, temperature or weather information) from an ambient sensor, and may use the received environment information as a source for creating a profile.

In accordance with various embodiments of the present disclosure, the electronic device 201 (e.g., the profile manager 260) may receive information related to another person (e.g., an exercise coach, a role model, a celebrity, an ambient person or a member of a group) from others' electronic devices 202˜204, and may use the received information of other people as a source for creating or updating a user's profile. For example, the electronic device 201 (e.g., the profile manager 260) may obtain information (e.g., information suitable for a user's target of exercise) suitable for a user from others' information by comparing user information with others' information. In this case, the target of exercise may be a diet, the strengthening of muscle, the strengthening of muscular endurance or aerobic exercise. The obtained information may be menu information, a running time/speed, weight type/time/number/posture or device setting information.

Others' information or information obtained from others' information may be modified according to a user's state/preference and used as an element of the profile of a user. For example, the exercise program of an exercise coach is used as the source of the profile of a user, but the exercise strength and time of the exercise coach may be changed and used as elements of the profile of the user. Information related to the exercise posture of an exercise coach may be modified suitably for a user's body. The exercise intensity of an exercise coach may be changed suitably for a user's strength. The exercise sequence of an exercise coach may be adjusted suitably for a user's preference.

The profile of a user may be changed by taking into consideration others' information or information (e.g., the exercise schedule of another person, another person's preference or a relationship between another person and the user) obtained from others' information. For example, a user's priority may be lowered with respect to exercise machinery that has been occupied or is to be occupied by another person. The profile of a user may be changed so that a users graphic user interface is properly displayed to the user with reference to others' graphic user interfaces.

The profile of a user may be changed so that collaboration is performed between other people and a user base don others' information or information obtained from others' information. For example, if five aerobic exercises are present, exercise may be terminated only when a user completes three exercises and other people completes the remaining two exercises.

Various types of the profiles of a user in addition to exercise may be changed based on another's profile. For example, various profiles may include a medical profile, a driving profile, a nutrition profile, an emotion profile and a sleep profile.

The electronic device 201 (e.g., the profile manager 260) may share another's profile used as a source for the creation or update of the profile of a user or another's profile modified by the user electronic device 201 with the electronic device of another person (third party). A user may recommend an ambient person who exercises together for the exercise profile (or modified exercise file) of an exercise coach who has exercise preference similar to the user, for example.

The electronic device according to various embodiments of the present disclosure includes a communication module and a processor operatively connected to the communication module. The processor may be configured to sense the generation of an event, to confirm whether the event is a selected event, to obtain information corresponding to one or more external electronic devices for the electronic device if the event is a selected event, and to perform the creation or update of a user profile corresponding to the user of the electronic device based on at least the information.

The electronic device further includes a first acquisition device for obtaining bio information and a second acquisition device for obtaining at least one of information related to the state of the portable electronic device and information related to an external environment. The processor may be configured to identify a user profile to be created if the event is the selected event, to check a target associated with the identified user profile, and to obtain information through at least one of the first acquisition device and the second acquisition device based on the checked target

The processor may be configured to receive information related to the type of the user profile from an external electronic device through the communication module. The target may have been associated with information related to the received type.

The processor may be configured to identify the type of user profile to be created to be at least one of exercise, nutrition, sleep, emotion and medical treatment using information received from the outside through the communication module.

The processor may be configured to identify the type of user profile to be created if the event is the selected event, to check a target associated with the user profile of the identified type, to obtain a user profile associated with the target, and to update the obtained user profile using at least some of the obtained information.

The obtained information may include information related to the capability of the external electronic device received by the processor from the external electronic device through the communication module.

The electronic device further includes an acquisition device for obtaining bio information. The processor may be configured to receive a user profile from an external device through the communication module, to obtain information associated with a target from the received profile, and to create a profile based on the obtained bio information using the associated information.

The processor may be configured to receive a user profile from an external electronic device through the communication module, to obtain changed information by comparing the received profile with a stored profile, and to update the stored profile using the changed information.

The processor may be configured to receive information related to a change of the state of an external electronic device from the external electronic device through the communication module and to update the created profile using the change information.

The electronic device further includes an acquisition device for obtaining at least one of information related to the state of the electronic device and information related to an external environment. The processor may be configured to change a target based on activity information obtained from the acquisition device and to update the created profile in accordance with the changed target.

The processor may be configured to control an external electronic device by transmitting at least some of the created profile to the external electronic device through the communication module.

The processor may be configured to update the created profile using information related to a schedule obtained from a calendar application.

The processor may be configured to update the created profile using a conversation obtained from a communication-related application.

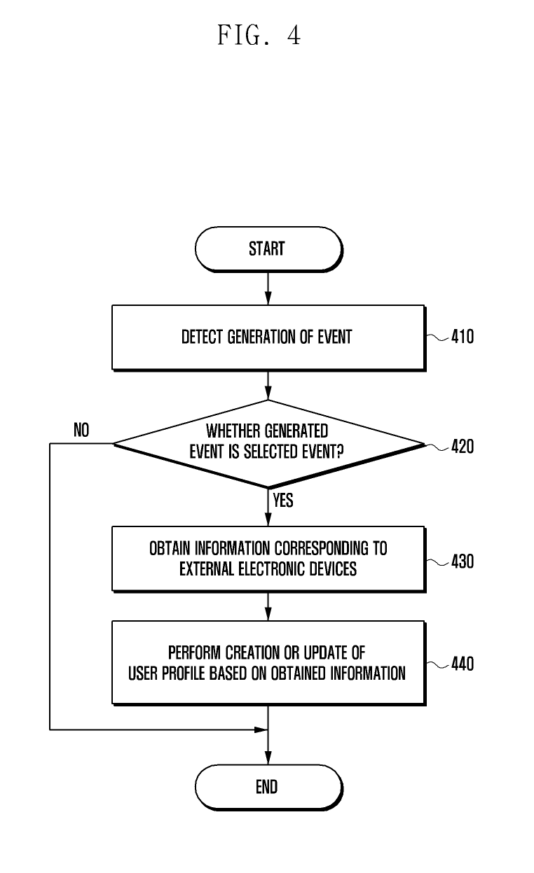

FIG. 4 is a diagram for illustrating a method of creating a profile according to various embodiments of the present disclosure.

Referring to FIG. 4, at operation 410, the electronic device 201 (e.g., the profile manager 260) may detect the generation of an event.

At operation 420, the electronic device 201 (e.g., the profile manager 260) may confirm whether a generated event is a selected event. For example, the selected event has been generated within the user electronic device 201, and may be related to at least one of an exercise schedule time according to a scheduler, a change of an ambient environment, a new schedule registration with a calendar, the activity of a user (e.g., exercise, bio information or schedule change input), schedule time input of periodic exercise, the driving of an application, a users location, user authentication, an information request from another's electronic device, a connection request from another's electronic device, the start of a service and the end of a service, for example. Furthermore, the selected event has been generated outside the user electronic device 201 and received by the user electronic device 201, and may be related to at least one of an environment (e.g., information related to a change of an approached ambient electronic device), a connection request, an information sharing request and the creation (or update) of another's profile, for example.

If the generated event is the selected event, at operation 430, the electronic device 201 (e.g., the profile manager 260) may obtain information corresponding to one or more external electronic devices 272˜274 for the user electronic device 201, in other words, the source of a profile to be created or updated. For example, the electronic device (e.g., the profile manager 260) may obtain information (e.g., in the case of an exercise profile, information collected from a running treadmill (e.g., the external electronic device 272) or information related to the exercise profile of another's electronic device (e.g., the user electronic devices 203˜204)), collected from a profile-specific device outside the user electronic device 201, as the source of the profile. Additionally, the electronic device 201 (e.g., the profile manager 260) may obtain a user's bio information as a source for the creation or update of the user profile. The user bio information may include information obtained by the sensor framework 230 of the user electronic device 201. Furthermore, the user bio information may include information obtained by a bio sensor mounted on a wearable device (e.g., the user electronic device 202) and received by the user electronic device 201 through the connectivity framework 220. Furthermore, the user bio information may include part of a user's medical record managed by a medical server (e.g., the server 271) and received by the user electronic device 201 through the connectivity framework 220. For example, the user bio information may include a user medical record, a nutrition state and calorie consumption information. Additionally, the electronic device 201 (e.g., the profile manager 260) may obtain information collected from a profile-related application within the user electronic device 201 and information collected from an application (e.g., a calendar, a scheduler or SNS) not directly associated with a profile within the electronic device as the source of a user profile to be created.

Additionally, at operation 430, the electronic device 201 (e.g., the profile manager 260) may identify the type of profile corresponding to the selected event. For example, when a user is recognized as being now located at any place (e.g., a fitness center) that cause the creation of a profile, the electronic device 201 (e.g., the profile manager 260) may identify the type of user profile to be workout based on the attributes of the identified place.

Additionally, at operation 430, the electronic device 201 (e.g., the profile manager 260) may check the user's target related to the user profile (e.g., an exercise profile, a nutrition profile or a sleep profile). In general, the user's target may have been selected by the user through an application related to the user profile. The target of the exercise profile may include, for example, calories consumed, calorie intake, the distance, an exercise time, a diet and an exercise mode (aerobic exercise, anaerobic exercise and the strengthening of muscle).

At operation 440, the electronic device 201 (e.g., the profile manager 260) may create a user profile based on at least the obtained information. If a created profile is already present, at operation 440, this may mean that at least some contents of the created profile is updated. An obtained source may become an element of the profile without processing or after it is processed. Alternatively, the electronic device 201 (e.g., the profile manager 260) may generate new data based on at least the obtained information and may determine it to be an element of the profile.

In accordance with some embodiments, if a profile to be created is an exercise profile, information collected from an ambient device related to the exercise profile may be used for the creation of the exercise profile. For example, the electronic device 201 (e.g., the profile manager 260) may receive device information related to aerobic exercise in ambient exercise machinery and may create an exercise profile including the control sequence and control parameter of the corresponding device. Furthermore, the electronic device 201 (e.g., the profile manager 260) may create an exercise profile based on a user target related to the exercise profile. For example, if the user target related to the exercise profile is aerobic exercise, the exercise profile including aerobic exercise may be created. Furthermore, a user profile may be created based on obtained user bio information. For example, the quantity of motion set within an exercise profile may be adjusted based on calories consumed by a user up to now. For another example, if vitamin A is insufficient in obtained user nutrition information, weight of secured vitamin A in the food configuration of a nutrition profile may be increased.

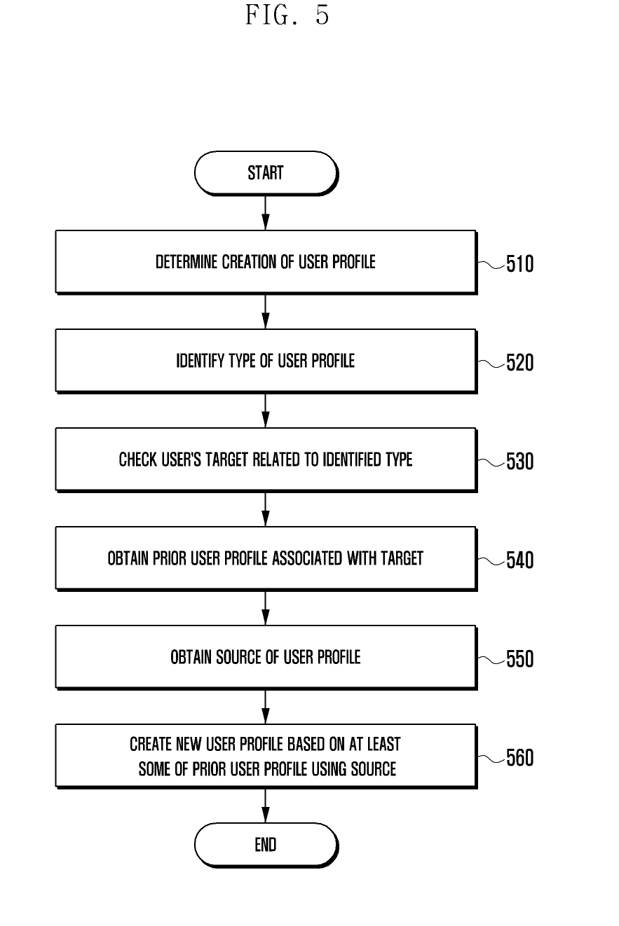

FIG. 5 is a diagram for illustrating a method of creating a profile using a prior profile according to various embodiments of the present disclosure.

Referring to FIG. 5, at operation 510, the electronic device 201 (e.g., the profile manager 260) may determine the creation of a user profile in response to the recognition of the activity (e.g., exercise) of a user as a selected event.

At operation 520, the electronic device 201 (e.g., the profile manager 260) may identify the type of user profile. For example, if the activity of a user is recognized as being exercise, the creation of an exercise profile may be determined. Since exercise and nutrition have a mutually influencing relationship, the identified type of the user profile may be determined to be a combination of exercise and nutrition. For another example, if the activity of a user is recognized as being get-together, the creation of a nutrition profile may be determined. Meanwhile, if, as a result of the tracking of a user's location, a hospital is periodically included in the flow of the user or information related to a medical history is included in the user's personal information, the electronic device 201 (e.g., the profile manager 260) may recognize that the user is in the state in which the user requires medical management. Accordingly, the electronic device 201 (e.g., the profile manager 260) may identify the type of profile to be a combination of nutrition and medical treatment.

At operation 530, the electronic device 201 (e.g., the profile manager 260) may check the user's target related to the identified type. For example, the target may include menu adjustment, aerobic exercise, anaerobic exercise and the strengthening of muscle.

At operation 540, the electronic device 201 (e.g., the profile manager 260) may obtain a prior profile associated with the target.

In accordance with one embodiment, the electronic device 201 (e.g., the profile manager 260) may obtain a profile corresponding to the target. The profile may include, for example, a profile that belongs to exercise profiles and that has been previously created in relation to the target (e.g., aerobic exercise). The user profile may include the elements of FIG. 3. The user profile has been created in a first environment (e.g., A fitness center), for example, and may include calories consumed by a user, exercise program information, an exercise distance, a bio signal measured upon exercise, device information used for the exercise, a control parameter, etc.

In accordance with another embodiment, if a user profile corresponding to the target is not present, a default profile may be used as a prior profile. For example, the default profile may have included only the bio signal 330 and personal information 340 of the elements of FIG. 3. Additionally, the default profile may further include preference information related to the identified type (e.g., exercise).

At operation 550, the electronic device 201 (e.g., the profile manager 260) may obtain profile-specific information, in other words, the source of a profile. In accordance with one embodiment, the electronic device 201 (e.g., the profile manager 260) may select a device that belongs to ambient devices searched for in a second environment (e.g., B fitness center), for example, and that is related to the target, and may receive information related to the capability, reliability and availability, for example, from the selected device as a source.

At operation 560, the electronic device 201 (e.g., the profile manager 260) may create a new user profile based on at least some of the prior profile using the obtained source. In other words, the electronic device 201 (e.g., the profile manager 260) may change a user profile used in a previous environment adaptively to a new environment using a source obtained in the new environment. Accordingly, a user can be provided with a similar experience, felt in the previous environment, even in a new environment (a different place and a different time) seamlessly. For example, if the quantity of motion performed in the running treadmill of a previous environment is “100”, the quantity of motion in the running treadmill of a current environment may be designated as 50 and the quantity of motion in the cycling machine of the current environment may be designated as 50. A running treadmill control parameter used in a previous running treadmill is maintained, so the running treadmill can be controlled as the same control parameter in a current environment. Since a prior profile does not include information related to cycling machine control, the quantity of motion may be set as 50 using a default cycling machine control parameter.

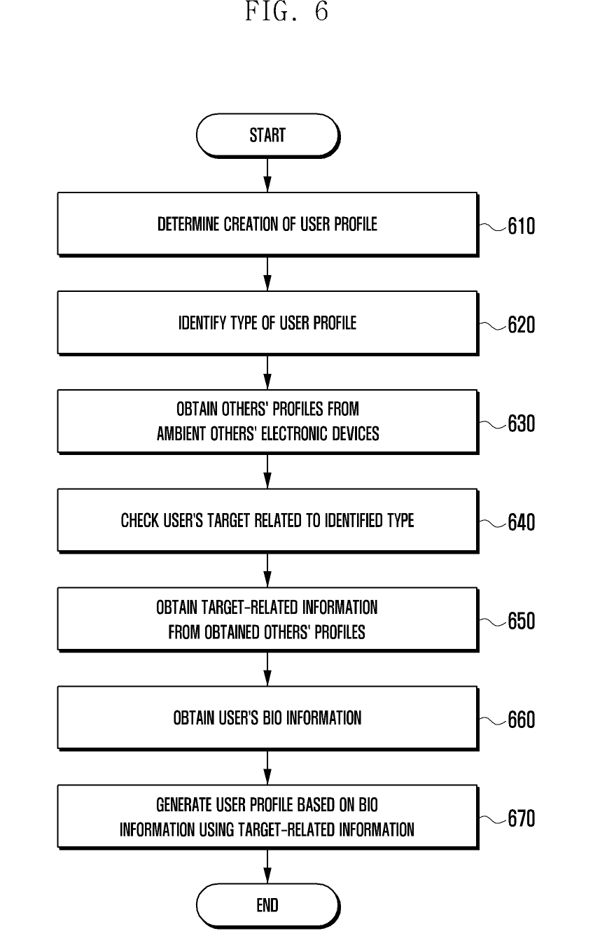

FIG. 6 is a diagram for illustrating a method of creating the profile of a user using another's profile according to various embodiments of the present disclosure.

Referring to FIG. 6, at operation 610, the creation of a user profile may be determined. In accordance with one embodiment, when the location of a user is recognized as being a selected place (e.g., a fitness center), the electronic device 201 (e.g., the profile manager 260) may determine the creation of a user profile.

At operation 620, the type of user profile may be identified. In accordance with one embodiment, the electronic device 201 (e.g., the profile manager 260) may identify the type of user profile based on the identified location of the user. For example, if the identified location is an exercise-related place, the identified type may include exercise. If the identified location is a food-related place, the identified type may include nutrition. If the identified location is a medical treatment-related place, the identified type may include medical treatment.

At operation 630, the electronic device 201 (e.g., the profile manager 260) may obtain others' profiles from ambient electronic devices 202˜204 of other people as a source for creating the profile of the user. For example, when the type of user profile is identified, an operation of receiving a user profile (or part of the user profile (e.g., a control parameter related to the identified type)) from others' electronic devices by searching for ambient electronic devices of other people may be performed. When a plurality of profiles is received from a plurality of others' electronic devices, an operation of selecting at least one (at least one person) from the received profiles may be additionally performed.

At operation 630, the selection may be performed based on the analysis of the received profile. For example, the electronic device 201 (e.g., the profile manager 260) may recognize who is another person based on another's profile (e.g., personal information). If another person is recognized as being an exercise coach or a celebrity, a corresponding another's profile may be selected as a source for creating the profile of the user. The selected profile may include, for example, a menu related to exercise, weight training, aerobic exercise and a control parameter. The menu may be a food menu helpful to a diet or may be a food menu helpful to the strengthening of muscle. The weight training may be information for the strengthening of muscle exercise, and may include the sequence of muscular strength exercises, the number of muscular strength exercises, and time information related to the muscular strength exercises, for example. The aerobic exercise may include information related to a running treadmill, cycling or a stepper. The control parameter may include information for controlling a device used in weight training and aerobic exercise.

At operation 640, the electronic device 201 (e.g., the profile manager 260) may check the user's target related to the identified type. For example, the target may have been selected through an application related to the profile.

At operation 650, the electronic device 201 (e.g., the profile manager 260) may obtain information related to related to the checked target from the obtained another's profile. For example, if the strengthening of muscle has been included in the selected target, information related to the strengthening of muscle exercise may be obtained from a received (or selected) profile. Additionally, menu information including food information suitable for the strengthening of muscle may be obtained. Furthermore, a parameter for control of a device to be used for the strengthening of muscle may be obtained.

At operation 660, the electronic device 201 (e.g., the profile manager 260) may obtain the user's bio information as a source for creating the profile of the user. The bio information may be information related to the current body state of the user and measured by a wearable device. The wearable device may be the user electronic device 201 itself or may be capable of wireless communication with the user electronic device 201. For example, information, such as a heart rate, body heat, a pulse and a degree of fatigue, may be measured by the wearable device. The bio information may be information stored in the user electronic device 201. For example, the users body type information, such as height and weight, information related to user nutrition, such as food allergy, and information, such as a current disease or symptom, may be stored in the user electronic device 201.

At operation 670, the electronic device 201 (e.g., the profile manager 260) may create a user profile based on the bio information using the target-related information.

The target-related information may be used after it experiences a change process. For example, food information for the strengthening of muscle may be changed according to a user nutrition state. If a user is a vegetarian, food information related to meat may be excluded. Furthermore, in the case of a nutrition state in which a users intake of protein is insufficient, the amount of food related to protein may be increased. An exercise profile for the strengthening of muscle may be changed according to the user state. For example, if a user is in a tired state, the time and number of the strengthening of muscle exercise may be reduced. A parameter for controlling a device used upon strengthening the muscle exercise may be changed according to the user state. For example, a control parameter may be changed suitably for body type information of the user.

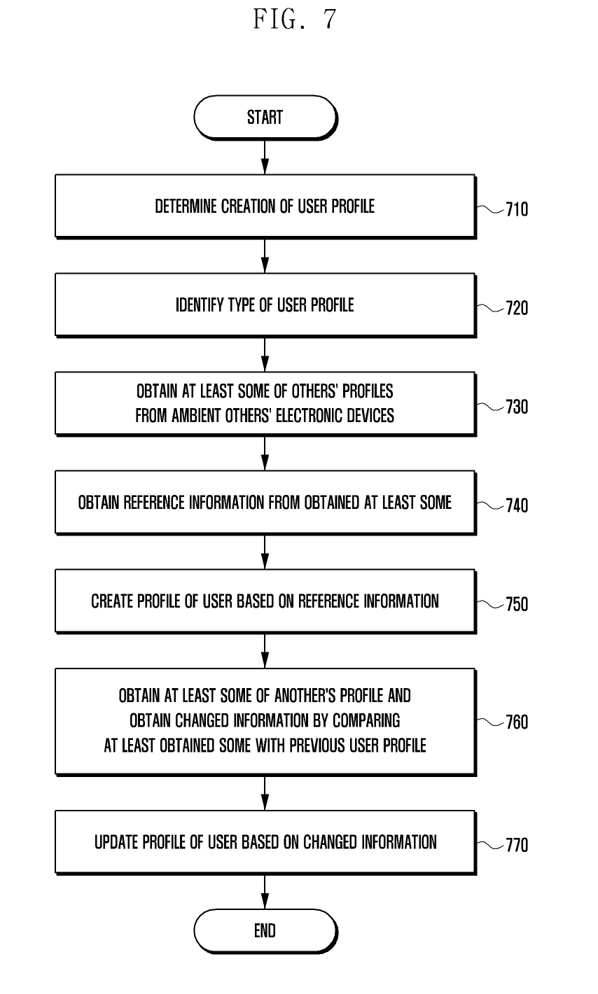

FIG. 7 is a diagram for illustrating a method of updating the profile of a user created with reference to another's profile according to various embodiments of the present disclosure.

Referring to FIG. 7, the electronic device 201 (e.g., the profile manager 260) may determine the creation of a user profile (operation 710), may identify the type of user profile (operation 720), and may obtain at least some of others' profiles from ambient others' electronic devices 202˜204 (operation 730).

Operation 730 may additionally include an operation of selecting, when electronic devices of other people are retrieved around the user electronic device 201, at least one (at least one person) of the retrieved electronic devices. To this end, who are other people may be recognized. Additionally, information (e.g., a geographical location, preference, activity or target) indicative of association between other people and a user may be obtained. For example, other people may include a person who is closest to the user, a person who is farthest from the user, a person who has preference identical with or similar to preference of the user, a person who has preference different from or opposite to preference of the user, a person who has activity identical with or similar to the activity of the user, a person who has activity different from or opposite to the activity of the user, a person who has a target identical with or similar to the target of the user, a person who has a target different from or opposite to the target of the user, a person who removes a device identical with or similar to the device of the user or a person who removes a device different from or opposite to the device of the user.

At operation 740, the electronic device 201 (e.g., the profile manager 260) may obtain reference information (e.g., information related to an identified type) from the obtained at least some.

At operation 750, the electronic device 201 (e.g., the profile manager 260) may create the profile of the user based on the obtained reference information.

At operation 760, the user electronic device 201 may obtain at least some of another's profile, may compare the obtained at least some with previous things (at least some obtained at operation 730), and may obtain changed information as the results of the comparison. Alternatively, operation 760 may include an operation of the user electronic device 201 requesting the changed information from another's electronic device and another's electronic device transmitting the changed information to the user electronic device 201 in response thereto.

At operation 770, the electronic device 201 (e.g., the profile manager 260) may update the profile of the user based on the changed information. The changed information may be automatically incorporated into the profile of the user. Alternatively, the changed information may be incorporated into the profile of the user in response to the user's selection. The changed information may include each changed element and changed cause of the profile. If another's profile is changed with reference to the profile of a third party, information including changed information in the profile of the thirty party and/or changed information in another's profile may be transmitted to the user electronic device 201.

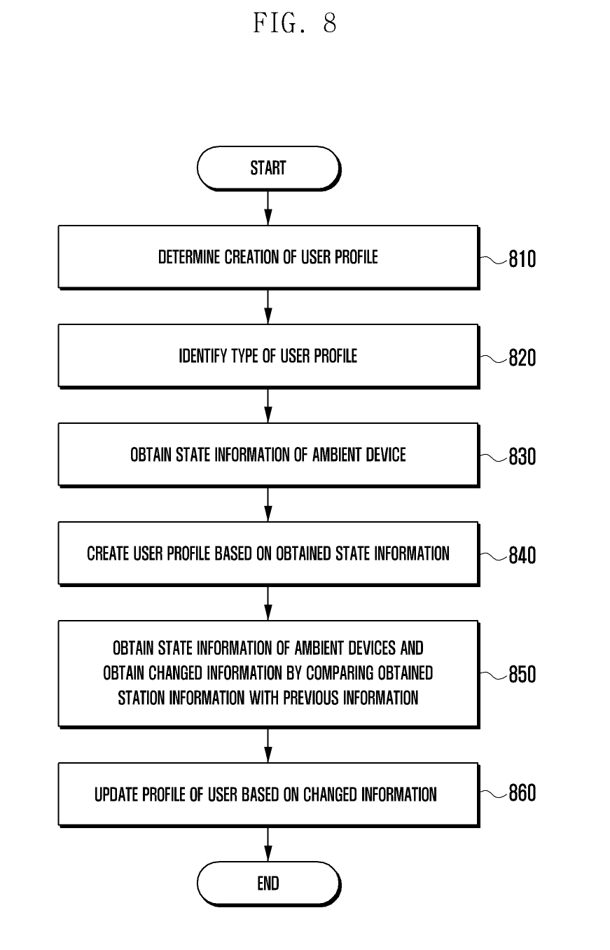

FIG. 8 is a diagram for illustrating a method of updating the profile of a user created with reference to the state of ambient devices according to various embodiments of the present disclosure.

Referring to FIG. 8, the electronic device 201 (e.g., the profile manager 260) may determine the creation of a user profile (operation 810) and identify the type of user profile (operation 820).

At operation 830, the electronic device 201 (e.g., the profile manager 260) may obtain state information of an ambient device. The state information may include, for example, changed setting information, information indicating whether the ambient device malfunctions, and information indicating whether the ambient device is being controlled by others' electronic devices 202˜204.

At operation 840, the electronic device 201 (e.g., the profile manager 260) may create the profile of the user based on the obtained state information.

At operation 850, the electronic device 201 (e.g., the profile manager 260) may obtain state information of the ambient device, may compare the obtained thing with a previous thing (the state information obtained at operation 830), and may obtain changed information as the results of the comparison. Alternatively, operation 850 may include an operation of the electronic device 201 (e.g., the profile manager 260) requesting the changed information from the ambient device and of the ambient device transmitting the changed information to the user electronic device 201 in response thereto. In accordance with another embodiment, if state information is changed in the ambient device, the ambient device may notify the user electronic device 201 of corresponding contents.

At operation 860, the electronic device 201 (e.g., the profile manager 260) may update the profile of the user based on the changed information. For example, the profile (type, for example, exercise or health) of the user may be created based on state information of an indoor temperature control device, and thereafter, setting for temperature control in the indoor temperature control device may be changed. A change of such setting may become one reason in updating the profile of the user. For another example, if exercise machinery in a fitness center malfunctions or is controlled by others' electronic devices 202˜204 (e.g., if other people have occupied the exercise machinery), the exercise profile of the user is updated.

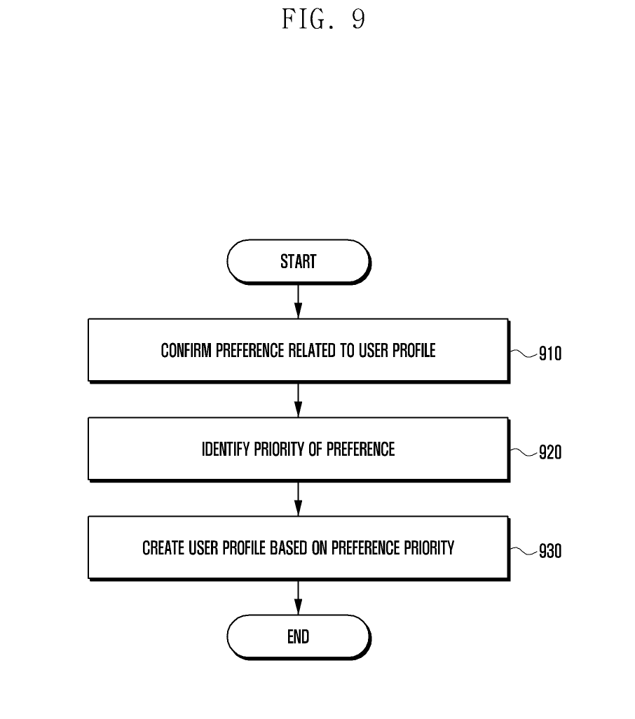

FIG. 9 is a diagram for illustrating a method of creating a profile based on preference according to various embodiments of the present disclosure.

Referring to FIG. 9, at operation 910, the electronic device 201 (e.g., the profile manager 260) may confirm preference related to a user profile.

At operation 920, the electronic device 201 (e.g., the profile manager 260) may identify the priority of preference. In the case of an exercise profile, the sequence of exercise preferred by a user may become preference. For example, in aerobic exercise, if a user more frequently uses a running treadmill than a cycling machine, preference priority of the running treadmill may be higher than that of the cycling machine. The preference priority may be selected by the user or may be trained by a user pattern and determined.

At operation 930, the electronic device 201 (e.g., the profile manager 260) may create a user profile based on the preference priority. For example, if the exercise target of a user is changed from aerobic exercise to the strengthening of muscle and thus preference priority of weight training becomes higher than that of the aerobic exercise, a user profile may be updated so that more time is assigned to the weight training than to the aerobic exercise.

The user's preference may include information to be selectively displayed in the user electronic device 201 or an ambient device. For example, the information to be displayed may include that heart rate information of a user is displayed in a selected GUI form during exercise. If an exercise profile is created using such preference, when the user uses a running treadmill, the heart rate information may be displayed on the display of the user electronic device 201 in the selected GUI form. In another embodiment, if an exercise profile is created using the preference, when the user uses a running treadmill, heart rate information of the user may be displayed on the display of the running treadmill in the selected GUI form.

The preference related to the user profile may include another's preference. Accordingly, the profile of the user may be created based on another's preference. If the user's preference is different from another's preference, a preference negotiation process may be performed. In the case of a selected another person, another's preference priority may be set higher than the user's preference priority. For example, if food preferences are different within a nutrition profile, a user's nutrition profile may be created by taking into consideration selected another's food preference.

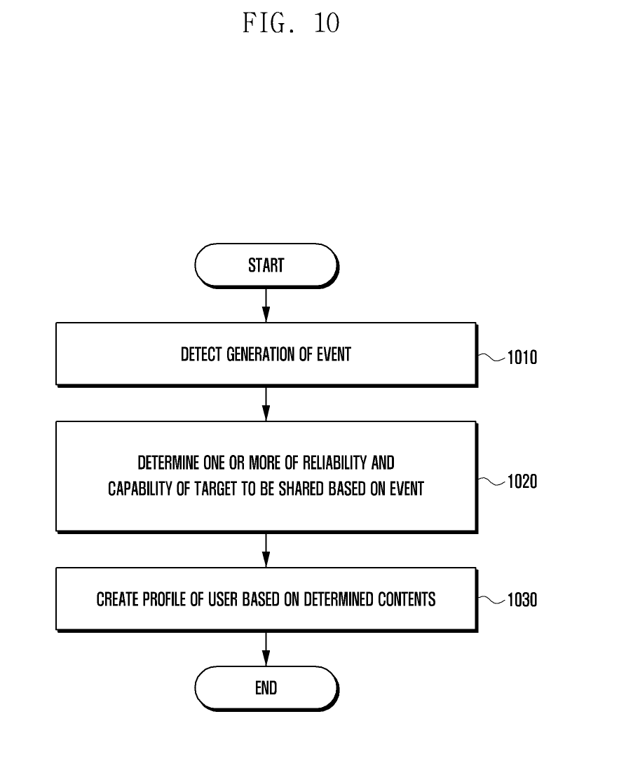

FIG. 10 is a diagram for illustrating a method of creating a user profile in response to the generation of an event related to a user profile according to various embodiments of the present disclosure. A user's electronic device may determine conditions for performing one or more of a user profile creation operation and an information sharing operation in response to the generation of an event, and may create a user profile for sharing information with one or more external devices or controlling an external device based on the corresponding conditions.

Referring to FIG. 10, at operation 1010, the electronic device 201 (e.g., the profile manager 260) may detect the generation of an event. For example, the event has been generated within the user electronic device 201, and may be related to at least one of an exercise schedule time according to a scheduler, a change of an ambient environment, the registration of a new schedule with a calendar, the start of the activity of a user, the end of the activity of the user, the driving of an application, a user's location, user authentication, an information request from another's electronic device, a connection request from another's electronic device, the start of a service and the end of the service, for example. Furthermore, the event has been generated outside the user electronic device 201 and received by the user electronic device 201, and may be related to at least one of a connection request, an information sharing request and the creation (or update) of another's profile, for example.

At operation 1020, the electronic device 201 (e.g., the profile manager 260) may determine one or more of the reliability and capability of an external device (information sharing target) based on the event. The evaluation of reliability by which the user electronic device 201 creates a user profile for sharing information (e.g., a user profile) with an external device or controlling an external device may be performed in advance (e.g., before the event is generated) or in response to the generation of the event. The reliability may include one or more of personal information protection, security and accuracy of provided information. The electronic device 201 (e.g., the profile manager 260) may evaluate reliability of the information sharing target by calculating the confidence level of the information sharing target (e.g., a device, a server, a person or a group). The electronic device 201 (e.g., the profile manager 260) may determine information to be shared based on the reliability.

Additionally, when the sharing information is determined, the electronic device 201 (e.g., the profile manager 260) may notify the user of the sharing information through a display or an audio device. The user may select whether to share the information, a sharing item or a sharing target. That is, operation 1020 may further include an operation of differently setting the operation mode of the user electronic device 201 based on the determined reliability. For example, if the user's personal information is included in the sharing information, the electronic device 201 (e.g., the profile manager 260) may display the corresponding personal information to the user in advance and perform an operation of performing a user's consent prior to sharing. If a user's personal information is not included in the sharing information, the profile manager 260 may omit a procedure of performing a user's consent.

At operation 1030, the electronic device 201 (e.g., the profile manager 260) may automatically create the profile of the user based on the determined contents (reliability and/or capability) in response to a user's selection or when the sharing information is determined.

Alternatively, at operation 1030, the electronic device 201 (e.g., the profile manager 260) may transmit the sharing information determined or selected by the user to an external device. Alternatively, at operation 1030, the electronic device 201 (e.g., the profile manager 260) may create the profile of the user and transmit at least some of the created user profile to an external device.

In accordance with various embodiments of the present disclosure, a reliability evaluation target is an information sharing target, and may include a device, a server, a person, a group and a company. The device may include, for example, a health care device and a biosensor-embedded IoT device. The server, person or group may include a content producer, a service provider and a server administrator. The reliability evaluation target may be content or service, such as an application or a website. For example, the reliability evaluation target may be a health coaching application, a fitness coaching service, nutrition, a food-related recommendation service and advertising.

In accordance with various embodiments of the present disclosure, the type of reliability may include personal information protection and security, accuracy, and the degree of intimacy with an information sharing environment.

In the personal information protection and security, a confidence level (CL) determination method may include whether a user has been authenticated and a method of authenticating a user, whether a safe security channel has been set and a method of setting a safe security channel when information is exchanged, whether data has been encrypted and a method of encrypting data when information is exchanged, and whether content has been authenticated and a method of authenticating content. Whether information requested by a device can specify a person may be evaluated by probability calculation. That is, the probability that who is a user can be estimated based on information provided to the device may be calculated. Whether a capability-based information request is proper may be determined. A CL based on propriety may be determined.

Accuracy may include the precision of provided information or service. The same bio information may have a different measurement unit or measurement precision depending on a measurement sensor. For example, electrocardiography (ECG) may be more excellent than photoplethysmography (PPG) in terms of precision.

Accuracy may include whether a measurement criterion/method is the same (e.g., the identity/similarity of a measurement device) and whether a measurement result unit is the same (e.g., a blood sugar unit when blood sugar is measured). A CL based on accuracy may be determined by collecting capability information of a device and making a determination based on the collected capability information. The authentication grade/standard grade of a device may be used to determine accuracy. For example, in the case of a health device, whether the health device has been approved by FDA may be used to determine accuracy. In the case of a speaker, sound reproducibility according to a class grade may be used to determine accuracy.

Accuracy may be determined using reputation. For example, health information provided by a hospital or research institute may be evaluated as having higher accuracy than information provided by a company. Real-time information provided by a fitness expert may be evaluated as having higher accuracy than recorded video information. Furthermore, the reputation of review information related to measurement accuracy of a device/service may be used to determine accuracy. Information recommended by an SNS user may be evaluated as having higher accuracy. For example, a hospital or expert and a company service recommended by users belonging to the same disease community may be evaluated as having high accuracy.

Accuracy may include the fidelity of display contents of an information source. Reliability may be differently determined depending on information related to the source of writing or information related to a writer, information related to identity including a site owner, whether a site is private or public, the name of a mother institute, and the mission and object of a site in addition to physical locations, such as an address, a telephone number and e-mail address, and the clear classification of advertising and information.

Accuracy may include evaluation based on the attributes of information. For example, an article's accuracy may be evaluated as being higher than advertising's accuracy. Recent information may be evaluated as being higher than previous information in terms of accuracy.

The degree of intimacy with an information sharing environment may be determined based on the providing history of existing information. For example, the history may include previous use information (determined based on a device identifier and location) and a target (person, device, site or company) that has previously shared information. The degree of intimacy may be determined whether a service is a previously subscribed service. For example, in the case of a previously subscribed service or device, the degree of intimacy may be relatively high. In the case of a newly subscribed service or first used device, the degree of intimacy may be low. The degree of intimacy may be determined based on the installation location or managing entity of a device. For example, a device installed in a user's house may have high reliability, whereas a device installed in a public place may have relatively low reliability. The degree of intimacy of a device installed in a fitness center to which a user has subscribed may be higher than the degree of intimacy of a device in the place that the user first visits. The degree of intimacy of a device installed in the place to/from which entrance/exit are restricted may be higher than that of a device installed in a public place.

In accordance with one embodiment reliability evaluation, a device, website and application installed in the place (sensed by inside/outside location recognition) having no visit history of a user's electronic device or a device, website and application having no use history may be primarily determined to have a low CL upon sensing. As the visit history or use history increases, the CL may be set higher (e.g., if a previous history is 100 times or more, the CL is 10, if there is no history, the CL is 0). The CL of an application, website or service associated with control of a user's electronic device may be determined. The CL of a device that excessively requires sensitivity information (e.g., personal information) may be secondarily determined. Furthermore, the CL may be changed depending on reliable community, the guarantee of a third party, and whether a certificate has been confirmed (distribution place, community, insurance company, and expert).

In accordance with various embodiments of the present disclosure, the electronic device 201 (e.g., the profile manager 260) may set an operation mode according to a CL. If the CL of a device is low, the sharing of information (e.g., bio information, a long-term profile, an exercise schedule, application information, and information (device information, service information) related to previous exercise) having high sensitivity may be excluded/blocked. Minimum information (e.g., weight and target calories consumed of the day in personal information) may be shared with a corresponding device. The user electronic device 201 may be prohibited from controlling a host/wearable, for example. Furthermore, a device having a low CL may be connected to another device in a one-to-one manner only.

If the CL of a device is relatively high, a corresponding device, for example, the profile manager 260 of the user electronic device 201 may share stored exercise/diet setting information and sensed bio information and provide a seamless exercise experience to a user. The electronic device 201 (e.g., the profile manager 260) may provide sensitive personal information to the corresponding device having a high CL. The electronic device 201 (e.g., the profile manager 260) may generate a user preference GUI and share it with a device having a high CL. Moreover, the corresponding device may control the user electronic device 201. The electronic device 201 (e.g., the profile manager 260) may create and share a user profile using other people/electronic device information. When a device having a high CL requests access personal information, the electronic device 201 (e.g., the profile manager 260) may notify a user of the request and query the user whether the user agrees with the request.

In accordance with various embodiments of the present disclosure, the electronic device 201 (e.g., the profile manager 260) may determine the capability of an information sharing target. The electronic device 201 (e.g., the profile manager 260) may confirm a function or service associated with another device in order to share information (e.g., a user profile) with another device or to control another device. The profile manager 260 of the user electronic device 201 may determine an available function or service of another device or whether the function or service of another device is available based on the confirmed information. Furthermore, the profile manager 260 of the user electronic device 201 may perform reliability evaluation based on the confirmed information.

The capability of one or more other devices operatively connected to a user electronic device may be used in a WoT environment, M2M and an IoT environment. One or more capabilities of the following contents may be determined using the aforementioned various standard or commercial technologies. The determined contents may be stored in one or more external devices 202˜204 (e.g., a wearable device, a server, and a smart home gateway) operatively connected to the user electronic device 201 or the user electronic device. Information that has been stored in the form of a file or database and that indicates the capability may be compared with information indicative of a previously collected capability. The previous information may be updated or modified based on a result of the comparison, and new information may be added. Furthermore, information indicative of the stored capability may be used as a service lookup table used for the check of the state, management and instruction of a device/function/service.

The capability may include the specification of a device. The specification may include the resources of a device such as display resolution, a supportable function, an API for control and information sharing, measurement accuracy, the type of measurement information, an operation ability and communication-related information. Furthermore, in this case, the specification of a device may include the specification of the user electronic device 201 and/or the specification of another device operatively connected to the user electronic device 201 and owned by a user.

The capability may include the ability to use information of another device, other people and another group and the ability to transmit information. For example, the capability may include the specification of an external device operatively connected to the user electronic device 201, the specification of a third device connected to an external device, the specification of a service related to another person or group on an external device connected to the user electronic device 201 or a server, and an information sharing range. In this case, the information sharing range may include an information sharing range on SNS, the device control range and control authority of a smart home, and the professional field of an expert or expert system on remote medical treatment. Furthermore, the capability may include an API for the utilization of a device and a parameter (required information).

An example of the collection of capability-related information is as follows. When a device/system to be connected by an event is recognized, the electronic device 201 (e.g., the profile manager 260) may determine whether the recognized device/system has the same type as an existing device with reference to a use history. If the recognized device/system has the same type, the existing capability information may be used as a source for the creation of a user profile. If the recognized device/system is a new device or has a different type, the electronic device 201 (e.g., the profile manager 260) may collect capability-related information from the recognized device/system.

The electronic device 201 (e.g., the profile manager 260) may collect or check information by accessing a server or gateway related to the device/system. For example, the electronic device 201 (e.g., the profile manager 260) may check or collect the capability of a running treadmill by accessing the server of a fitness center. When the user electronic device 201 enters a smart home environment or a smart office environment, the electronic device 201 (e.g., the profile manager 260) may check or collect the capability of the smart home or office device by accessing a gateway. The electronic device 201 (e.g., the profile manager 260) may check or collect the capability if a corresponding device by accessing a manufacturing company website. The electronic device 201 (e.g., the profile manager 260) may check whether the download of a driver or application is necessary, and may perform an installation operation if the download of the driver or application is necessary. The electronic device 201 (e.g., the profile manager 260) may check the capability of a specific device using NFC or a protocol, such as ANT+.

In accordance with various embodiments of the present disclosure, the management range of a service lookup may include the specification/API (control/request processing-possible method) of a single device, a group (a connection with another device within a group over a network and the ability of another device to use information) of a device, and other people (e.g., the character and field of a doctor, diet coach, fitness center coach, family or community).

In accordance with various embodiments of the present disclosure, the operation method (the operation of a user profile) of a device using service lookup may include a direct control method and a request method. The direct control method may include a direct control method for another device that is operatively connected through the user electronic device 201. For example, the user electronic device 201 may directly generate a GUI to be drawn in a wearable device and transmit it to the wearable device. The user electronic device 201 may directly control the speed and exercise time of a running machine based on a target of exercise set in the electronic device 201 by a user. The request method may include a method of receiving a user's intention/target from a device in a request form and automatically controlling the intention/target. For example, when a user electronic device transmits weight and a target of calories consumed to a running machine based on a target of exercise set in the electronic device 201 by a user, the running machine may calculate speed and an exercise time. When a user transmits information related to the frequently used GUI of an electronic device to an external device, the external device may similarly draw the corresponding GUI based on its own display resolution and input device.

Table 1 is an example of a device operation in which reliability and capability have been incorporated. In the device operation, if a users personal information or bio information is taken into consideration, whether or not to share information and a level of sharing may be different based on the reliability and capability of a device. Furthermore, the user electronic device 201 may differently operate a device according to the direct control method or the request method based on the capability of the device.

TABLE 1

| Reliability (CL) | Capability | User profile | Operation | Service |
|---|---|---|---|---|
| Reliability is high | Electronic | Personal | Electronic device contro [symbol] | Provides GUI of device in preference |
| (device/system) | device controls | information is | function of external device | form preferred by user |
| | function contro [symbol] | shared i [symbol] | based on user profile | Select and control things required by |
| | of device | necessary | Permit reception of exercise [symbol] | user from functions of device/system |
| | | | related feedback (exercise | through wearable |
| | | | information, user electroni [symbol] | Receive and update feedback, such as |
| | | | device control instruction) from | exercise coaching/results |
| | | | device/center system | |
| | Required | Personal | Electronic device shares use [symbol] | Wearable measures heart rate during |
| | | exercise target | profile (personal information, | user exercise and transmits it to device |
| | | Bio information | such as exercise target) with | Recommend and automatically contro [symbol] |
| | | Schedule | external device/system | quantity of motion/exercise metho [symbol] |
| | | information | External device/system | based on bio information/contac [symbol] |
| | | | automatically adjusts quantity | center/coach upon emergency |
| | | | of motion | |
| Reliability is low | Electronic | Not shared | Simple function control | Transmit simple control instruction, |
| | device controls | | Prohibit reception of feedback | such as function (e.g., speed o [symbol] |
| | function contro [symbol] | | of external device | running treadmill) of device |
| | of device | | | User electronic device determines |
| | | | | quantity of motion |
| | Required | Anonymous | Provide minimum information | Transmit detailed activity and minimum |
| | | personal | | personal information for achieving |
| | | information | | exercise target |
| | | | | Ex: target amount of calories |
| | | | | consumed and weight |
| | | | | User electronic device determines |
| | | | | actual quantity of motion |

[symbol]

indicates data missing or illegible when filed

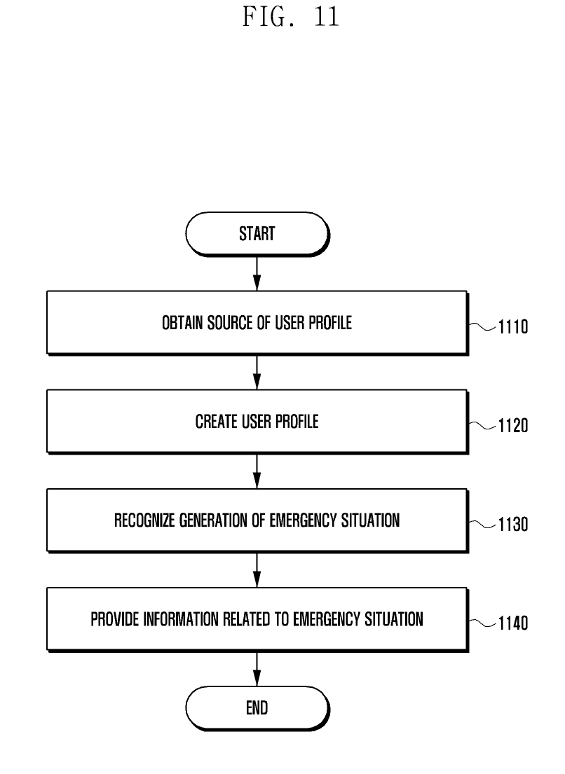

FIG. 11 is a diagram for illustrating an operating method of an electronic device using the profile of a user according to various embodiments of the present disclosure. In accordance with one embodiment, a user may be incapable of doctor communication or may be passive infants or a disabled person. A user profile may have been created to handle the emergency situation (e.g., the intake of food that causes allergy or that has been contaminated or the generation of a safe accident) of such infants or a disabled person.

Referring to FIG. 11, at operation 1110, the electronic device 201 (e.g., the profile manager 260) may obtain the source of a user profile. For example, the electronic device 201 (e.g., the profile manager 260) may obtain a bio signal (e.g., a heart rate, blood pressure and body heat) through the sensor framework 230. Furthermore, the electronic device 201 (e.g., the profile manager 260) may obtain device information around a user, location information, and others' information around a user through the connectivity framework 220.

At operation 1120, the electronic device 201 (e.g., the profile manager 260) may create a user profile based on the obtained source. For example, the profile may include a bio signal, information (e.g., a body heat threshold or location information) for determining whether an emergency situation has occurred, and a user's personal information.

At operation 1130, the electronic device 201 (e.g., the profile manager 260) may recognize the generation of an emergency situation. In accordance with one embodiment, the electronic device 201 (e.g., the profile manager 260) may monitor a change of the bio signal. The electronic device 201 (e.g., the profile manager 260) may compare the results of the monitoring with the user profile. If, as a result of the comparison, there is a sudden change in the bio signal (e.g., the body heat exceeds a threshold (e.g., 39 degrees) recorded on the user profile), the electronic device 201 (e.g., the profile manager 260) may recognize that an emergency situation has occurred in the user. In accordance with one embodiment, the electronic device 201 (e.g., the profile manager 260) may monitor a change of circumstances. If, as a result of the monitoring, for example, a user (infants) deviates from a given place (e.g., kindergarten), it may be recognized that an emergency situation has occurred.

At operation 1140, the user electronic device 201 may provide information related to the emergency situation. In accordance with one embodiment, the electronic device 201 (e.g., the profile manager 260) may output an alarm sound at a maximum volume. Additionally or alternatively, the electronic device 201 (e.g., the profile manager 260) may display emergency situation information on a screen. Furthermore, the electronic device 201 (e.g., the profile manager 260) may transmit the emergency situation information (e.g., a sudden rise of the body heat) to a preset external device (e.g., the electronic device of parents or family doctor, a selected medical facility or a medical personnel). Alternatively, the user electronic device 201 may recognize an ambient device (e.g., the electronic device of a nursing teacher) through an obtained source, and may transmit the emergency situation information to the recognized ambient device. The emergency situation information may include user personal information, user bio information measured in an emergency situation and user medical history information if the user profile is a health profile, for example. Furthermore, the emergency situation information may include information (e.g., bio information or location information) stored in the electronic device 201, user behavior information (e.g., information measured through an acceleration sensor or information measured through a motion sensor), and history information of executed applications.

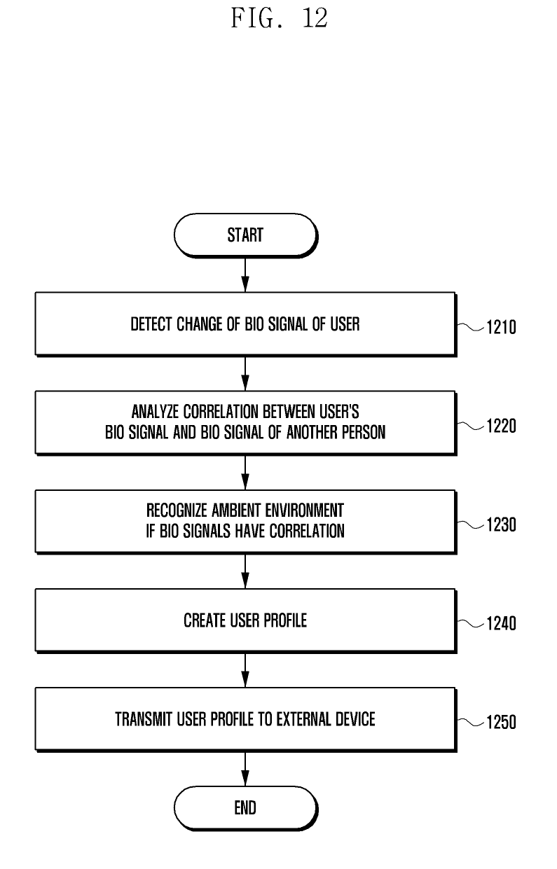

FIG. 12 is a diagram for illustrating an operation method of an electronic device using a user profile according to various embodiments of the present disclosure. In accordance with one embodiment, a user may be incapable of doctor communication or may be passive infants or a disabled person. A user profile may have been created to handle the emergency situation (e.g., the abuse of a nursing teacher) of such infants or a disabled person.

Referring to FIG. 12, at operation 1210, the electronic device 201 (e.g., the profile manager 260) may detect a change of an obtained bio signal (heart rate information, electrocardiogram information, blood pressure information, oxygen saturation information, skin moisture ratio information, stress information or an emotion state) through the sensor framework 230.

If there is a sudden change of the bio signal (e.g., a pulse exceeds a given threshold), at operation 1220, the electronic device 201 (e.g., the profile manager 260) may analyze a correlation between the user's bio signal and the bio signal of another person (e.g., other infants) obtained from an ambient device. The bio signal of another person may be obtained from a profile (e.g., health profile) received from another person.

If, as a result of the comparison, the bio signals have a correlation (e.g., if the user's a pulse is not identical with the pulse of another person within a preset error range), at operation 1230, the electronic device 201 (e.g., the profile manager 260) may recognize an ambient environment. For example, the electronic device 201 (e.g., the profile manager 260) may identify the current location (e.g., kindergarten) of the user based on location information obtained from an ambient device through the connectivity framework 220.

At operation 1240, the electronic device 201 (e.g., the profile manager 260) may create a user profile based on the obtained source. For example, the profile may include a bio signal, information indicative of a correlation, an image captured using a camera, and a user's personal information.

At operation 1250, the electronic device 201 (e.g., the profile manager 260) may transmit the created profile of the user to an external device (e.g., the electronic device of parents).

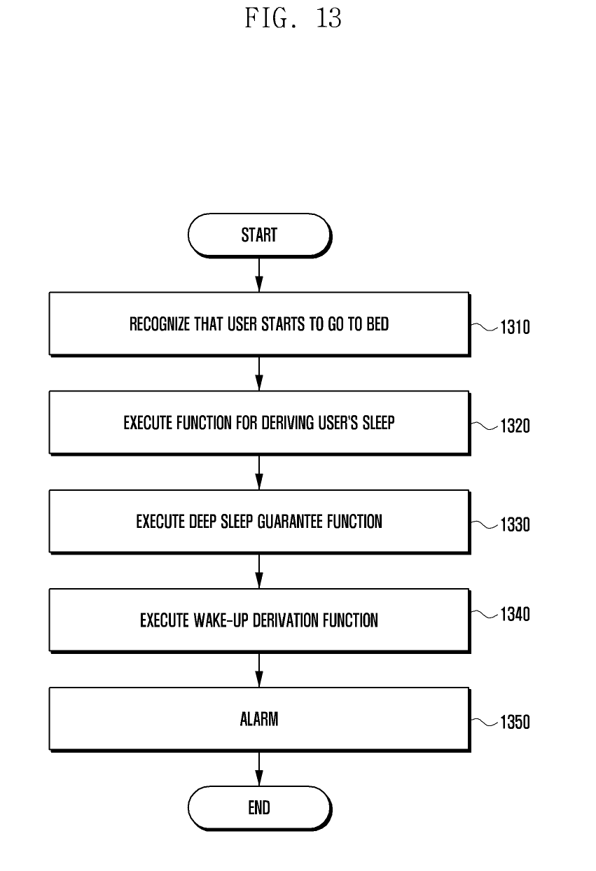

FIG. 13 is a diagram for illustrating an operation method of an electronic device using a sleep profile according to various embodiments of the present disclosure.

Referring to FIG. 13, at operation 1310, the electronic device 201 (e.g., the profile manager 260) may recognize that a user starts to go to bed. For example, the electronic device 201 (e.g., the profile manager 260) may monitor the user's state (e.g., a motion and breathing), circumstances (e.g., brightness), and the user's location through sensors in real time, and may determine whether the user starts to go to bend based on a result of the monitoring.

If it is recognized that the user starts to go to bed, at operation 1320, the electronic device 201 (e.g., the profile manager 260) may execute a function for deriving the user's sleep based on a sleep profile. For example, the electronic device 201 (e.g., the profile manager 260) may adjust temperature and humidity in the bed so that the user can sleep a quick sleep by remotely controlling a cooling device or a heating device. Furthermore, the electronic device 201 (e.g., the profile manager 260) may adjust the intensity of light of a lamp. If the location of the user is recognized as being accommodations (e.g., hotel), the electronic device 201 (e.g., the profile manager 260) may remotely control a device at corresponding accommodations using device control setting information included in a sleep-causing function used at home. Additionally, the electronic device 201 (e.g., the profile manager 260) may monitor the user's sleep state by monitoring the user's bio signal in real time.

If, as a result of the monitoring, the user was recognized as going to sleep, at operation 1330, the electronic device 201 (e.g., the profile manager 260) may execute a deep sleep guarantee function so that the user can sleep a deep sleep. For example, the electronic device 201 (e.g., the profile manager 260) may control an external device so that the deep sleep is guaranteed.

Prior to a set alarm time, at operation 1340, the electronic device 201 (e.g., the profile manager 260) may execute a wake-up derivation function for slowly waking the user up. For example, the electronic device 201 (e.g., the profile manager 260) may play music at a low volume by remotely controlling an audio device. If it is expected that the user will wake up from the sleep by sensing a user's bio change, the electronic device 201 (e.g., the profile manager 260) may execute a wakeup derivation function for slowly waking the user up.

At operation 1350, the electronic device 201 (e.g., the profile manager 260) may sound an alarm at a set alarm time.

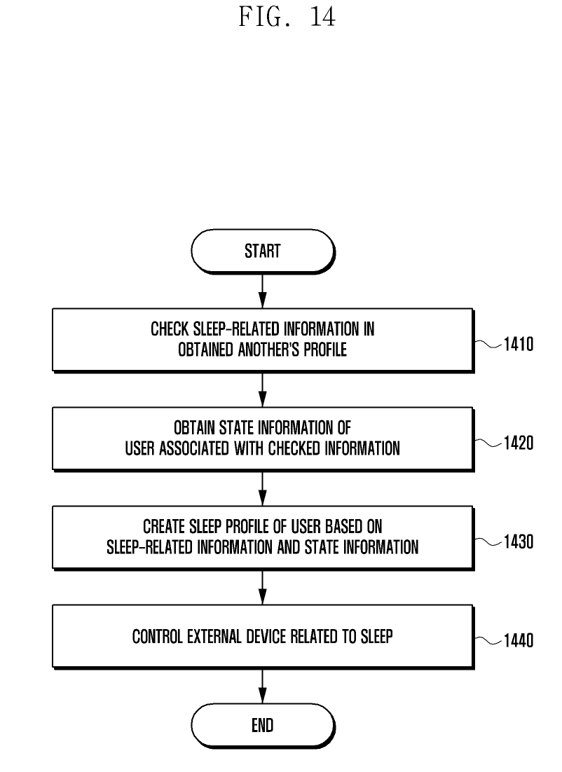

FIG. 14 is a diagram for illustrating an operation method of an electronic device using a sleep profile according to various embodiments of the present disclosure.

Referring to FIG. 14, at operation 1410, the electronic device 201 (e.g., the profile manager 260) may check sleep-related information (e.g., information related to insomnia, hypnolepsy, a sleep apnea syndrome or somnambulism) in an obtained another's profile.

At operation 1420, the electronic device 201 (e.g., the profile manager 260) may obtain state information (e.g., breathing, a motion or body heat) of a user associated with the checked information through a sensor.

At operation 1430, the electronic device 201 (e.g., the profile manager 260) may create the sleep profile of the user based on the sleep-related information and the state information. For example, the electronic device 201 (e.g., the profile manager 260) may adjust a control parameter for sleep to correspond to the measured state information or the sleep-related information. Furthermore, the electronic device 201 (e.g., the profile manager 260) may adjust the control parameter based on another's sleep profile. For example, if the state of a baby is a cold in the baby's sleep profile information and body heat is determined to be high, the electronic device 201 (e.g., the profile manager 260) may change a control parameter included in the user's sleep profile. For example, if temperature of a cooling device has been set to 25 degrees in the sleep profile, the electronic device 201 (e.g., the profile manager 260) may change the control parameter in order to raise the temperature or stop the driving of the cooling device depending on the state of the baby.

When the user goes to sleep, at operation 1440, the electronic device 201 (e.g., the profile manager 260) may control an external device (e.g., a cooling device, a heating device or a light) related to sleep based on the sleep profile.

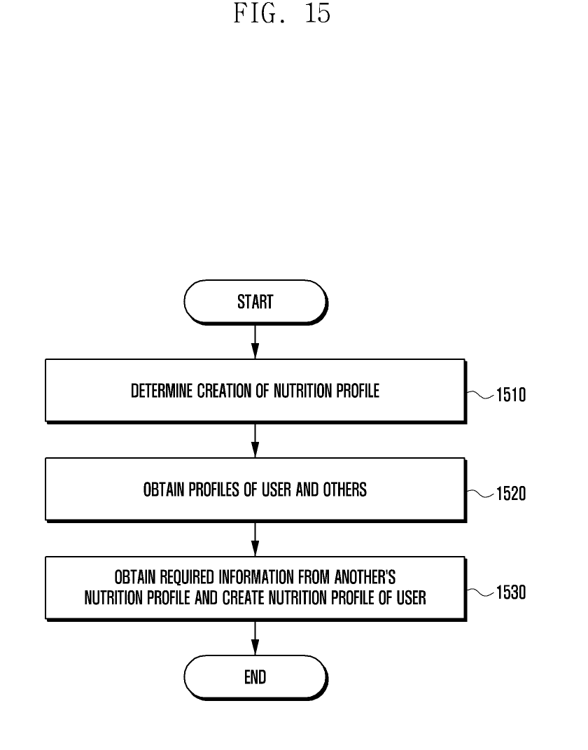

FIG. 15 is a diagram for illustrating an operation method of an electronic device using a nutrition profile according to various embodiments of the present disclosure.

Referring to FIG. 15, at operation 1510, the electronic device 201 (e.g., the profile manager 260) may determine the creation of a nutrition profile. For example, the electronic device 201 (e.g., the profile manager 260) may identify the current location of the user electronic device 201 based on information received from a server or a recognized ambient device. For example, if the current location is identified to be a place near a restaurant, the creation of a nutrition profile may be determined. For another example, if the present time is recognized as being a meal time (e.g., a lunch time or a meal time registered with a schedule) or time near the meal time, the creation of a nutrition profile may be determined.

At operation 1520, the electronic device 201 (e.g., the profile manager 260) may obtain the profile of the user and another's profile. Another's profile may be obtained from others' electronic devices 202˜204 around the user electronic device 201 or may be obtained from the electronic device of a person who has been registered with a schedule, for example. The obtained another's profile may include a preference food type, a preference food style (e.g., meat, vegetarian diet, Korean food, Chinese food or Western food), and information related to a preference restaurant. Additionally, the obtained another's profile may include information related to the current bio information and nutrition state of other people.

At operation 1530, the electronic device 201 (e.g., the profile manager 260) may create(update) the user profile by obtaining required information from the obtained another's profile. The obtained required information may include information related to the preference food, type, style or restaurant of the user, for example. Furthermore, the obtained required information may include information related to the nutrition state of the user. The electronic device 201 (e.g., the profile manager 260) may add information related to a recommended food or restaurant, for example, to the user profile based on the obtained required information. A user's target may be added when the profile is created. For example, if the user's target is a diet, at operation 1530, the electronic device 201 (e.g., the profile manager 260) may create a profile for recommending a diet menu.

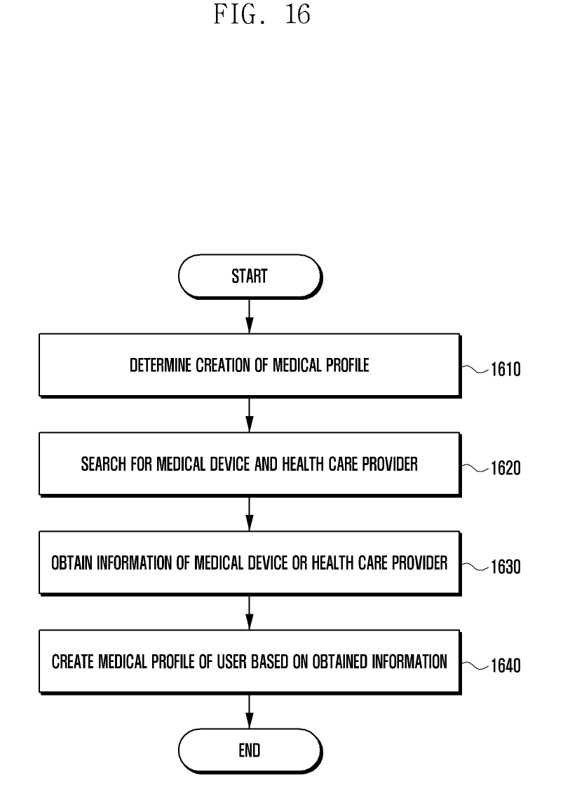

FIG. 16 is a diagram for illustrating an operation method of an electronic device using a medical profile according to various embodiments of the present disclosure.

Referring to FIG. 16, at operation 1610, the electronic device 201 (e.g., the profile manager 260) may determine the creation of a medical profile. For example, the electronic device 201 (e.g., the profile manager 260) may identify the current location of the user electronic device 201 based on information received from a server or a recognized ambient device. For example, when the current location is identified to be a medical facility (a hospital, drug store or health center) or the place near the medical facility, the creation of a medical profile may be determined. For another example, when the present time is recognized as being a selected medicine taking time (e.g., a lunch time or a medicine taking time registered with a schedule) or time close to the selected medicine taking time, the creation of a medical profile may be determined. For another example, when the present time is recognized as being consultation hours registered with a schedule or time close to the consultation hours, the creation of a medical profile may be determined.

At operation 1620, the electronic device 201 (e.g., the profile manager 260) may search for a medical device and a health care provider by scanning surroundings through the connectivity framework 220. The retrieved medical device may include a device capable of measuring bio information (e.g., blood pressure, a heart rate, blood sugar, weight, body fat, oxygen saturation, electrocardiogram or electromyogram), for example. The electronic device 201 (e.g., the profile manager 260) may obtain others' information from the retrieved ambient device and determine whether the user of the corresponding device is a medical treatment-related practician (e.g., a doctor, a first aider or a nurse) based on the obtained information.

At operation 1630, the electronic device 201 (e.g., the profile manager 260) may obtain information of the retrieved medical device or information of the health care provider from a corresponding external device (i.e., the medical device or the electronic device of the health care provider) through the connectivity framework 220. For example, the obtained information may include the capability of a device capable of measuring bio information, information related to reliability and availability, information related to the professional field or qualification of the health care provider, and information (e.g., the medical history of the retrieved health care provider, the patient list of the health care provider, and information indicating whether the retrieved health care provider has been authenticated) indicative of a relationship between the health care provider and a user.

At operation 1640, the electronic device 201 (e.g., the profile manager 260) may create the medical profile of the user based on the obtained information. The created profile may include the current bio information of the user, a user medical history, a medical treatment history, and a parameter for control of a bio information measurement device. At least some (e.g., bio information) of the created profile may be encrypted and may be decrypted when other people are authenticated.

The method performed in the electronic device according to various embodiments of the present disclosure may include sensing the generation of an event; confirming whether the event is a selected event; obtaining information corresponding to one or more external electronic devices for the electronic device if the event is the selected event; and performing the creation or update of a user profile corresponding to the user of the electronic device based on at least the information.

The obtaining may include determining the user profile corresponding to the event; and selecting the one or more external electronic devices corresponding to the user profile from a plurality of external electronic devices.

The determining may include determining the type of user profile to be created to be at least one of exercise, nutrition, sleep, an emotion and medical treatment using information received from the outside.

The obtaining may include obtaining the information from the one or more external electronic devices using the communication module operatively connected to the electronic device or the information from a memory operatively connected to the electronic device.

The performing may include obtaining context information of the user corresponding to the electronic device; and performing the creation or update of the user profile based on the context information.

The performing may include providing a service based on the user profile.

The providing may include providing use information corresponding to the one or more external electronic devices.

The obtaining may include checking a target associated with the determined user profile and obtaining the information through an acquisition device operatively connected to the electronic device based on the checked target.

The method further includes receiving information related to the type of profile from an external electronic device. The target may have been associated with information related to the received type.

The obtaining may include checking a target associated with the determined user profile and obtaining the user profile associated with the target. The obtained profile may be updated based on at least the information. The information may include information related to the capability of an external electronic device received from the external electronic device.

The method may further include obtaining bio information and obtaining information associated with a given target from a user profile received from an external electronic device. The user profile may be created based on the associated information and the bio information.

The obtain may include obtaining changed information by comparing a user profile received from an external electronic device with the previously stored user profile. The previously stored user profile may be updated using the changed information.

The method further includes receiving information related to a change of the state of an external electronic device. The user profile may be updated using the state change information.

The method further includes obtaining at least one of information related to the state of the electronic device and information related to an external environment and setting a target associated with the user profile based on the obtained at least one information. The user profile may be updated using the set target.

The method may further include controlling an external electronic device by transmitting at least some of the user profile to the external electronic device.

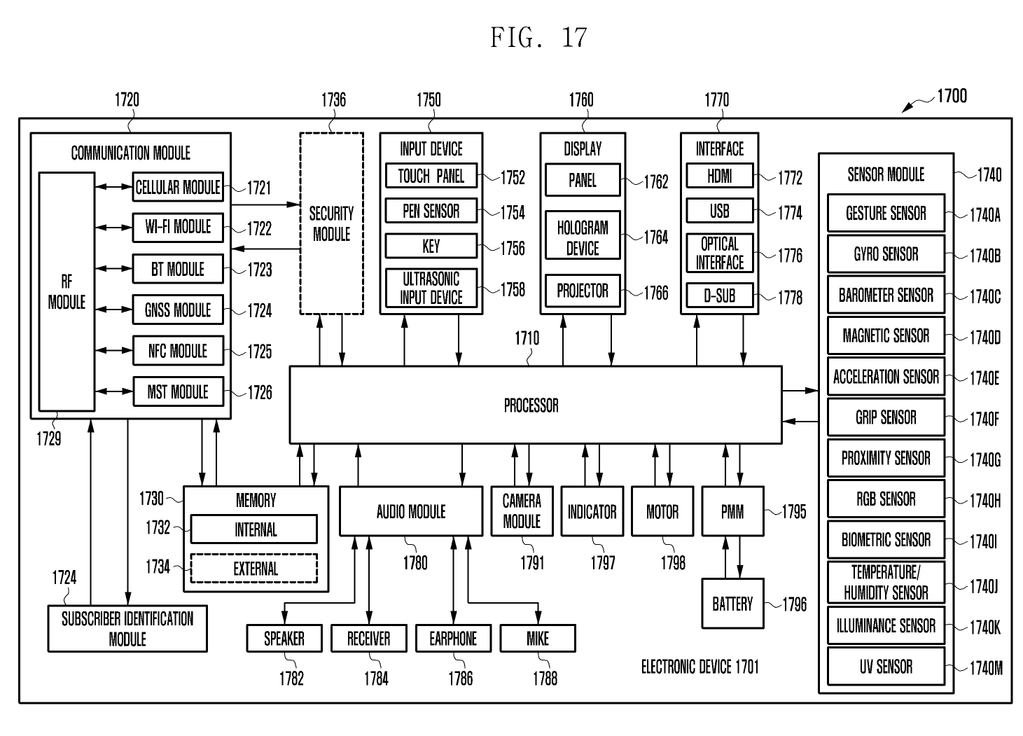

FIG. 17 is a block diagram 1700 showing an electronic device 1701 according to various embodiments. The electronic device 1701 may include some of or the entire electronic device 101 shown in FIG. 1, for example. The electronic device 1701 may include one or more processors (e.g., an application processor (AP)) 1710, a communication module 1720, a subscriber identity module 1729, memory 1730, a sensor module 1740, an input device 1750, a display 1760, an interface 1770, an audio module 1780, a camera module 1791, a power management module 1795, a battery 1796, an indicator 1797 and a motor 1798.

The processor 1710 may control a plurality of hardware or software elements connected to the processor 1710 by driving an operating system or application program, for example, and may perform a variety of types of data processing and operations. The processor 1710 may be implemented as a system on chip (SoC), for example. In accordance with one embodiment, the processor 1710 may further include a graphic processing unit (GPU) and/or an image signal processor. The processor 1710 may include at least some (e.g., the cellular module 1721) of the elements shown in FIG. 17. The processor 1710 may load an instruction or data received from at least one of other elements (e.g., nonvolatile memory) onto volatile memory, may process the instruction or data, and may store various data in nonvolatile memory.

The communication module 1720 may have a configuration identical with or similar to the communication interface 170 of FIG. 1. The communication module 1720 may be an element of the connectivity framework 220 of FIG. 2, and may include, for example, a cellular module 1721, a WiFi module 1722, a Bluetooth module 1723, a GNSS module 1724 (e.g., a GPS module, a Glonass module, a Beidou module or a Galileo module), an NFC module 1725, an MST module 1726 and a radio frequency (RF) module 1727.

The cellular module 1721 may provide a voice call, a video call, a text service or an Internet service over a communication network, for example. In accordance with one embodiment, the cellular module 1721 may perform the identification and authentication of the electronic device 1701 within a communication network using the subscriber identity module (e.g., SIM card) 1729. In accordance with one embodiment, the cellular module 1721 may perform at least some functions of functions that may be provided by the processor 1710. In accordance with one embodiment, the cellular module 1721 may include a communication processor (CP).

Each of the WiFi module 1722, the Bluetooth module 1723, the GNSS module 1724, the NFC module 1725 and the MST module 1726 may include a processor for processing data transmitted/received through a corresponding module, for example. In accordance with some embodiments, at least some (e.g., two or more) of the cellular module 1721, the WiFi module 1722, the Bluetooth module 1723, the GNSS module 1724, the NFC module 1725 and the MST module 1726 may be included in a single integrated chip (IC) or IC package.

The RF module 1727 may transmit/receive a communication signal (e.g., an RF signal), for example. The RF module 1727 may include, for example, a transceiver, a power amp module (PAM), a frequency filter, a low noise amplifier (LNA) or an antenna. In accordance with another embodiment, at least one of the cellular module 1721, the WiFi module 1722, the Bluetooth module 1723, the GNSS module 1724, the NFC module 1725 and the MST module 1726 may transmit/receive an RF signal through a separate RF module.

The subscriber identity module 1729 may include a card and/or embedded SIM including a subscriber identification module, for example, and may include unique identifier information (e.g., an integrated circuit card identifier (ICCID)) or subscriber information (e.g., an international mobile subscriber identity (IMSI)).

The memory 1730 (e.g., the memory 130) may include embedded memory 1732 or external memory 1734, for example. The embedded memory 1732 may include at least one of volatile memory (e.g., dynamic RAM (DRAM), static RAM (SRAM) or synchronous dynamic RAM (SDRAM)) and non-volatile memory (e.g., one time programmable ROM (OTPROM), programmable ROM (PRM), erasable and programmable ROM (EPROM), electrically erasable and programmable ROM (EEPROM), mask ROM, flash ROM, flash memory (e.g., NAND flash or NOR flash), a hard disk or a solid state drive (SSD)), for example.

The external memory 1734 may further include a flash drive, for example, compact flash (CF), secure digital (SD), micro secure digital (micro-SD), mini secure digital (mini-SD), extreme digital (xD), a multi-media card (MMC) or a memory stick. The external memory 1734 may be connected to the electronic device 1701 through various interfaces operatively and/or physically.

The security module 1736 is a module including a storage space having a relatively higher security level than the memory 1730, and may be a circuit that stores safe data and guarantees a protected execution environment. The security module 1736 may be implemented as a separate circuit and may include a separate processor. The security module 1736 may be present within a detachable smart chip or a secure digital (SD) card, for example, or may include an embedded secure element (eSE) within the fixed chip of the electronic device 1701. Furthermore, the security module 1736 may be driven by an operating system different from the operating system (OS) of the electronic device 1701. For example, the security module 1736 may be driven based on a java card open platform (JCOP) operating system.

The sensor module 1740 may measure, for example, a physical quantity or sense the operating state of the electronic device 1701, and may convert the measured or sensed information into an electric signal. The sensor module 1740 may be an element of the sensor framework 230 of FIG. 2, and may include at least one of a gesture sensor 1740A, a gyro sensor 1740B, an atmospheric sensor 1740C, a magnetic sensor 1740D, an acceleration sensor 1740E, a grip sensor 1740F, a proximity sensor 1740G, a color sensor 1740H (e.g., a red, green and blue (RGB) sensor), a bio sensor 1740I, a temperature/humidity sensor 1740J, an illumination sensor 1740K and a UV ultra violet sensor 1740M, for example. Additionally or additionally or alternatively, the sensor module 1740 may include, for example, an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 1740 may further include a control circuit for controlling one or more sensors included therein. In some embodiments, the electronic device 1701 further includes a processor configured to control the sensor module 1740 as part of the processor 1710 or separately from the processor 1710, and may control the sensor module 1740 while the processor 1710 is in a sleep state.

The input device 1750 may include, for example, a touch panel 1752, a (digital) pen sensor 1754, a key 1756 or an ultrasonic input device 1758. The touch panel 1752 may use at least one method of capacitive, decompression, infrared and ultrasonic methods, for example. Furthermore, the touch panel 1752 may further include a control circuit. The touch panel 1752 further includes a tactile layer and may provide a tactile response to a user.

The (digital) pen sensor 1754 may be part of the touch panel, for example, or may include a separate sheet for recognition. The key 1756 may include, for example, a physical button, an optical key or a key pad. The ultrasonic input device 1758 may sense ultrasonic waves generated from an input tool through a microphone (e.g., microphone 1788), and may check data corresponding to the sensed ultrasonic waves.

The display 1760 (e.g., the display 160) may include a panel 1762, a hologram device 1764 or a projector 1766. The panel 1762 may have a configuration identical with or similar to the display 160 of FIG. 1. The panel 1762 may be implemented, for example, flexibly, transparently or in a wearable manner. The panel 1762 may be configured as one module along with the touch panel 1752. The hologram device 1764 may display a stereoscopic image in the air using interference of light. The projector 17662 may display an image by projecting light onto a screen. The screen may be located inside or outside the electronic device 1701, for example. In accordance with one embodiment, the display 1760 may further include a control circuit for controlling the panel 1762, the hologram device 1764 or the projector 1766.

The interface 1770 may include, for example, a high-definition multimedia interface (HDMI) 1772, a universal serial bus (USB) 1774, an optical interface 1776 or a D-subminiature (D-sub) 1778. The interface 1770 may include, for example, the communication interface 170 shown in FIG. 1. Additionally or alternatively, the interface 1770 may include, for example, a mobile high-definition link (HML) interface, a secure digital (SD) card/multi-media card (MMC) interface or an infrared data association (IrDA) standard interface.

The audio module 1780 may convert, for example, sound and an electric signal interactively. At least some element of the audio module 1780 may include, for example, the input/output interface 145 shown in FIG. 1. The audio module 1780 may process sound information input or output through the speaker 1782, the receiver 1784, the earphone 1786 or a microphone 1788, for example.

The camera module 1791 is a device capable of capturing a still image and a moving image, for example. In accordance with one embodiment, the camera module may include one or more image sensors (e.g., a front sensor and a rear sensor), a lens, an image signal processor (ISP) or a flash (e.g., an LED or xenon lamp).

The power management module 1795 may manage power of the electronic device 1701, for example. In accordance with one embodiment, the power management module 1795 may include a power management integrated circuit (PMIC), a charger integrated circuit (IC) or a battery or a fuel gauge. The PMIC may have a wired and/or wireless charging method. The wireless charging method includes, for example, a magnetic resonance method, a magnetic induction method or an electromagnetic method, and may further include an additional circuit for wireless charging, for example, a coil loop, a resonant circuit or a rectifier. The battery gauge may measure, for example, the amount of remaining battery power of the battery 1796 and a voltage, a current or temperature during charging. The battery 1796 may include, for example, a rechargeable battery and/or a solar battery.

The indicator 1797 may display a specific state of the electronic device 1701 or part hereof (e.g., the processor 1710), for example, a booting state, a message state or a charging state. The motor 1798 may convert an electrical signal into mechanical vibration, and may generate vibration or a haptic effect. Although not shown, the electronic device 1701 may include a processing device (e.g., GPU) for mobile TV support. The processing device for mobile TV support may process, for example, media data based on standards, such as digital multimedia broadcasting (DMB), digital video broadcasting (DVB) or mediaFlo™.

Each of the elements described in this document may include one or more components, and the name of a corresponding element may be different depending on the type of electronic device. In various embodiments, the electronic device may be configured to include at least one of the elements described in this document, and some elements may be omitted or additional element may be further included. Furthermore, some of the elements of the electronic device according to various embodiments may be combined to form a single entity, and may perform the function of corresponding elements in the same manner before they are combined.

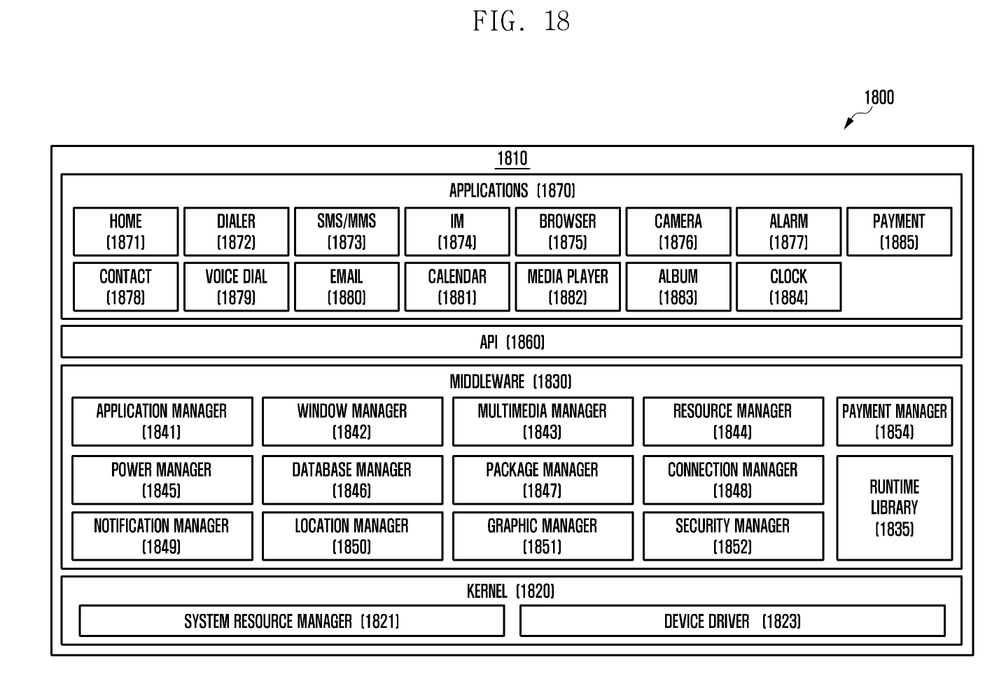

FIG. 18 is a block diagram 1800 showing a program module 1810 according to various embodiments. In accordance with one embodiment, the program module 1810 (e.g., the program 140) may include an operating system (OS) that controls resources related to an electronic device (e.g., the electronic device 101) and/or various applications (e.g., the application program 147) driven on the operating system. The operating system may be, for example, Android, iOS, Windows, Symbian, Tizen or Bada.

The program module 1810 may include a kernel 1820, middleware 1830, an application programming interface (API) 1860 and/or an application 1870. At least some of the program module 1810 may be preloaded onto the electronic device or may be downloaded from an external electronic device (e.g., the electronic device 102, 104, the server 106).

The kernel 1820 (e.g., the kernel 141) may include, for example, a system resources manager 1821 and/or a device driver 1823. The system resources manager 1821 may perform control, allocation or recovery of system resources. In accordance with one embodiment, the system resources manager 1821 may include a process management unit, a memory management unit or a file system management unit. The device driver 1823 may include, for example, a display a driver, a camera driver, a Bluetooth driver, sharing memory driver, a USB driver, a keypad driver, a WiFi driver, an audio driver or an inter-process communication (IPC) driver.

The middleware 1830 may provide, for example, a function required by the application 1870 in common or may provide various functions to the application 1870 so that the application 1870 can efficiently use limited system resources within the electronic device through the API 1860. In accordance with one embodiment, the middleware 1830 (e.g., the middleware 143) may include at least one of a runtime library 1835, an application manager 1841, a window manager 1842, a multimedia manager 1843, a resource manager 1844, a power manager 1845, a database manager 1846, a package manager 1847, a connectivity manager 1848, a notification manager 1849, a location manager 1850, a graphic manager 1851, a security manager 1852 and a payment manager 1854. Additionally, the middleware 1830 may include a profile manager (e.g., the profile manager 260).

The runtime library 1835 may include a library module used by a compiler in order to add a new function through a programming language while the application 1870 is executed, for example. The runtime library 1835 may perform a function for input/output management, memory management or arithmetic function.

The application manager 1841 may manage the life cycle of at least one application of the application 1870, for example. The window manager 1842 may manage GUI resources used by a screen. The multimedia manager 1843 may identify a format necessary for the playback of various media files and perform the encoding or decoding of a media file using a codec suitable for a corresponding format. The resource manager 1844 may manage the source code, memory or storage space of resources of at least any one application of the application 1870.

The power manager 1845 may manage the battery or power while operating in conjunction with a basic input/output system (BIOS), for example, and may provide power information necessary for the operation of the electronic device. The database manager 1846 may generate, search or change a database to be used in at least one application of the application 1870. The package manager 1847 may manage the installation or update of an application distributed in the form of a package file.

The connectivity manager 1848 may manage a wireless connection, such as WiFi or Bluetooth. The notification manager 1849 may display or notify an event, such as a received message, an appointment or proximity notification, in such a way as to not hinder a user. The location manager 1850 may manage location information of the electronic device. The graphic manager 1851 may manage a graphic effect to be provided to a user or a user interface related to the graphic effect. The security manager 1852 may provide an overall security function related to system security or user authentication. In accordance with one embodiment, if the electronic device (e.g., the electronic device 101) includes a telephone function, the middleware 1830 may further include a telephony manager for managing the voice or video call function of the electronic device. The payment manager 1854 may relay information for payment from the application 1870 to the application 1870 or the kernel 1820. Furthermore, the payment manager 1854 may store information related to payment received from an external device in the electronic device 1700 or may transmit information stored therein to an external device.

The middleware 1830 may include a middleware module that forms a combination of various functions of the aforementioned elements. The middleware 1830 may provide a module specific to the type of an operating system in order to provide a different function. Furthermore, the middleware 1830 may dynamically delete some of the existing elements or add new elements.

The API 1860 (e.g., the API 145) is a set of API programming functions, for example, and may be provided as a different configuration according to an operating system. For example, in the case of Android or iOS, one API set may be provided for each platform. In the case of Tizen, two or more API sets may be provided for each platform.

The application 1870 (e.g., the application program 147) may include, for example, a home 1871, a dialer 1872, SMS/MMS 1873, an IM instant message 1874, a browser 1875, a camera 1876, an alarm 1877, a contact 1878, a voice dial 1879, e-mail 1880, a calendar 1881, a media player 1882, an album 1883, a watch 1884, payment 1885, and one or more applications capable of performing functions, such as health care (e.g., measure the quantity of motion or blood sugar) and environment information provision (e.g., provide atmospheric pressure, humidity or temperature information).

In accordance with one embodiment, the application 1870 may include an application (hereinafter “information exchange application”, for convenience of description) that supports information exchange between the electronic device (e.g., the electronic device 101) and an external electronic device (e.g., the electronic device 102, 104). The information exchange application may include a notification relay application for delivering specific information to an external electronic device or a device management application for managing an external electronic device, for example.

For example, the notification relay application may include a function of relaying notification information, generated from a different application (e.g., SMS/MMS application, e-mail application, health management application or environment information application) of the electronic device, to an external electronic device (e.g., the electronic device 102, 104). Furthermore, the notification relay application may receive notification information from an external electronic device, for example, and provide it to a user.

The device management application may perform at least one function (e.g., the turn-on/turn-off of an external electronic device itself (alternatively, some components) or control of brightness (alternatively, resolution) of the display) of an external electronic device (e.g., the electronic device 102, 104) communicating with the electronic device, for example, and may manage (e.g., install, delete or update) an application operating in an external electronic device or services (e.g., a call service or message service) provided by an external electronic device.

In accordance with one embodiment, the application 1870 may include the attributes (application selected according to the attributes (e.g., the health management application of a mobile medical device) of an external electronic device (e.g., the electronic device 102, 104). In accordance with one embodiment, the application 1870 may include an application received from an external electronic device (e.g., the server 106 or the electronic device 102, 104). In accordance with one embodiment, the application 1870 may include a preloaded application or a third party application downloadable from a server. The names of the elements of the program module 1810 according to embodiments may be different depending on the type of operating system.

In accordance with various embodiments, at least some of the program module 1810 may be implemented as software, firmware, hardware or a combination of at least two or more of them. At least some of the program module 1810 may be implemented (e.g., executed) by the processor (e.g., the processor 1710), for example. At least some of the program module 1810 may include a module, program, routine, sets of instructions or process for performing one or more functions, for example.

The “module” used in this document may mean an unit including a combination of one or two or more of hardware, software and firmware, for example. The “module” may be interchangeably used with a term, for example, an unit, logic, a logical block, a component or a circuit. The “module” may be a minimum unit of an integrated part or part thereof. The “module” may be a minimum unit performing one or more functions or part thereof. The “module” may be implemented mechanically or electronically. For example, the “module” may include at least one of an application-specific integrated circuit (ASIC) chip, field-programmable gate arrays (FPGAs) and a programmable-logic device which perform some operations and which have been known or are to be developed.

At least some of the devices (e.g., modules or functions thereof) or the methods (e.g., operations) according to various embodiments may be implemented as instructions stored in computer-readable storage media in the form of a program module, for example. If the instructions are executed by a processor (e.g., the processor 120), one or more processors may perform functions corresponding to the instructions. The computer-readable storage media may be, for example, the memory 130.

The computer-readable storage media may include a hard disk, a floppy disk, magnetic media (e.g., magnetic tape), optical media (e.g., compact disc read only memory (CD-ROM), a digital versatile disc (DVD) and magneto-optical media) (e.g., a floptical disk)), and hardware devices (e.g., read only memory (ROM), random access memory (RAM) and flash memory). Furthermore, the program instructions may include high-level language code executable by a computer using an interpreter in addition to machine code, such as that generated by a compiler. The aforementioned hardware device may be configured to operate as one or more software modules in order to perform operations of various embodiments and the vice versa.

The module or program module according to various embodiments may include at least one of the aforementioned elements, may partially omit the aforementioned elements or may further include additional other elements. The operations performed by the module, the program module or other elements according to various embodiments may be executed in a sequential, parallel, repetitive or heuristic manner. Furthermore, some operations may be executed in a different sequence or may be omitted or may further include other operations. Furthermore, the embodiments disclosed in this document have been proposed for the description and understanding of the disclosed technical contents, and are not intended to restrict the scope of the technology disclosed in this document. Accordingly, the scope of this document should be construed as including all of medications or various other embodiments based on the technical spirit of this document.

1. An electronic device, comprising:
a communication module; and
a processor, wherein the processor is configured to:
sense a generation of an event;
confirm whether the event is a selected event;
obtain information corresponding to one or more external electronic devices for the electronic device if the event is the selected event; and
perform a creation or update of a user profile corresponding to a user of the electronic device based on at least the information.

2. The electronic device of claim 1, further comprising:
a first acquisition device configured to obtain bio information; and
a second acquisition device configured to obtain at least one of information related to a state of the electronic device and information related to an external environment,
wherein the processor is configured to:
identify a user profile to be created if the event is the selected event and check a target associated with the identified user profile, and
obtain information through at least one of the first acquisition device and the second acquisition device based on the checked target.

3. The electronic device of claim 2, wherein:
the processor is configured to receive information related to a type of user profile from an external electronic device through the communication module, and
the target is associated with the received information related to the type.

4. The electronic device of claim 1, wherein the processor is configured to determine a type of the user profile to be created to be at least one of exercise, nutrition, sleep, an emotion and medical treatment using externally received information through the communication module.

5. The electronic device of claim 1, wherein the processor is configured to:
determine a type of a user profile to be created if the event is the selected event,
check a target associated with the user profile of the determined type,
obtain the user profile associated with the target, and
update the obtained user profile using at least some of the information.

6. The electronic device of claim 1, wherein the information comprises information related to a capability of an external electronic device received by the processor from the external electronic device through the communication module.

7. The electronic device of claim 1, further comprising an acquisition device configured to obtain bio information,
wherein the processor is configured to:
receive a user profile from an external electronic device through the communication module,
obtain information associated with a target from the received user profile, and
generate a user profile based on the associated information and the bio information.

8. The electronic device of claim 1, wherein the processor is configured to:
receive a user profile from an external electronic device through the communication module,
obtain changed information by comparing the received user profile with a stored user profile, and
update the stored user profile using the change information.

9. The electronic device of claim 1, wherein the processor is configured to:
receive information related to a change of a state of an external electronic device from the external electronic device through the communication module, and
update the user profile using the state change information.

10. The electronic device of claim 1, further comprising an acquisition device configured to obtain at least one of information related to a state of the electronic device and information related to an external environment,
wherein the processor is configured to:
set a target associated with the user profile based on the information obtained from the acquisition device, and
update the user profile to correspond to the set target.

11. The electronic device of claim 1, wherein the processor is configured to control an external electronic device by transmitting at least some of the user profile to the external electronic device through the communication module.

12. The electronic device of claim 1, wherein the processor is configured to update the user profile using information related to a schedule obtained from a calendar application or a conversation obtained from a communication-related application.

13. A method of an electronic device, comprising:
sensing a generation of an event;
confirming whether the event is a selected event;
obtaining information corresponding to one or more external electronic devices for the electronic device if the event is the selected event; and
performing a creation or update of a user profile corresponding to a user of the electronic device based on at least the information.

14. The method of claim 13, wherein the obtaining comprises receiving the information from the one or more external electronic devices using a communication module operatively connected to the electronic device or obtaining the information from a memory operatively connected to the electronic device.

15. The method of claim 13, wherein the performing comprises:
obtaining a user's context information corresponding to the electronic device; and
performing the creation or update of the user profile further based on the context information.
